(19) United States
(12) Patent Application Publication
(10) Pub. No.: US 2017/0015584 A1
(43) Pub. Date: Jan. 19, 2017

(54) ASYMMETRICALLY STRUCTURED THIN GLASS SHEET THAT IS CHEMICALLY STRENGTHENED ON BOTH SURFACE SIDES, METHOD FOR ITS MANUFACTURE AS WELL AS USE OF SAME

(71) Applicant: Schott AG, Mainz (DE)

(72) Inventors: Marta Krzyzak, Bad Gandersheim (DE); Dirk Apitz, Lousanne (DE); Matthias Brueckner, Eisfeld (DE); Thomas Joerdens, Gruenenplan (DE); Marten Walther, Alfeld (DE)

(73) Assignee: Schott AG, Mainz (DE)

(21) Appl. No.: 15/208,942

(22) Filed: Jul. 13, 2016

(30) Foreign Application Priority Data
Jul. 13, 2015 (DE) 10 2015 213 075.4

(51) Int. Cl. C03C 21/00; C03C 4/18

(52) U.S. Cl. CPC C03C 21/002; C03C 4/18; C03C 2204/00

(57) ABSTRACT

A thin glass sheet includes a first and a second surface side, wherein the thin glass sheet is asymmetrically structured in that the two surface sides differ from one another, wherein both surface sides are chemically strengthened and wherein respectively a depth of layer exists of the alkali ions that are introduced through chemical strengthening, whereby the depth of layer of the first surface side (DoL₁) and the depth of layer of the second surface side (DoL₂) are coordinated with each other in such a way that they are equal or are adapted on both surface sides, and that on both surface sides respectively a coating consisting of one or several layers is provided, wherein the coating on the first surface side differs from the coating on the second surface side in at least one property or characteristic.

### BACKGROUND OF THE INVENTION

1. Field of the Invention

The current invention relates to an asymmetrically structured, thin glass sheet that is chemically strengthened as well as a method for manufacture and use thereof.

2. Description of the Related Art

Thin glass is well-known and is currently used in the form of thin plate- or sheet-shaped glass substrates, frequently as a protective or cover glass, for example for smart phones or tablet PCs. The demands upon such glass substrates are extremely high and are still increasing. The glass substrates should, in particular, have as little deformation as possible, and at the same time possess as great a hardness as possible in order to offer a scratch resistant surface. User friendliness during use should not be compromised due to disturbing reflexes in the substrate and, if necessary, it should have a dirt repellent surface and/or a surface that is easily cleaned.

Thus, optically effective layers for glasses that have an anti-reflection coating to, for example, increase the contrast of a display device are increasingly being offered on the market. This may, for example, cause a low optic reflectivity in an antireflective coating. However, glasses are increasingly directly adhered on the backside with a display device. This so-called optic bonding occurs through an adhesive whose refractive index has been adjusted to the surface of the display device and the glass. Thus, optical reflections can be avoided at the interface location. If this method is used, the backside of the described glass sheet can no longer be provided with an optical functional layer, since this would cause interfering reflexes on the inside of the adhered bond. This leads increasingly to sheets being required on which an optical functional layer is applied on only one side which is chemically strengthened in order to achieve greater strength.

In addition to an asymmetry based on a coating present on only one side, there is also a manufacturing based asymmetry. Due to the different media with which the top side and the bottom side of the glass ribbon come in contact, different glass surfaces having different internal tensions and different properties thus result in the production of thin glass substrates in a float process. These may contribute to undesired deformations in the thin glass substrate.

To increase hardness, scratch-, impact- and flexural strength, the protective or cover glasses are often strengthened, whereby thinner glass substrates cannot be strengthened thermally, but rather only chemically. Chemical strengthening of glass substrates is described for example in DE 10 2007 009 785 A1, DE 10 2007 009 786 A1 and DE 10 2012 213 071 A1.

In chemical strengthening, a compressive stress is frequently produced in a region close to the surface of the substrate. Chemical strengthening of surfaces having different internal tensions and properties can therefore lead to an asymmetry of the tensions in the glass substrate, since forces of different strengths act upon the glass. This results in deformation of the glass substrate, in particular of a thin glass substrate, thus making use of the thin glass substrate as cover glass for smart phones or tablet PCs no longer possible. Distortion or deformation impairs also the subsequent treatment and processing methods for the glass sheet, for example application of coating, separation into smaller units or post-processing.

It is, however, of great technical and economic advantage to be able to provide thin glasses prior to chemical strengthening with a coating, since this can be implemented on large formats. Chemical strengthening can be performed with the finished blanks, including the final edge finishing. Due to the downstream chemical strengthening, the processed edges also have increased strength. However, in order to avoid bending during chemical strengthening, only the chemical blank can first be provided with a coating. This is expensive and cost-intensive.

From the current state of the art, a method for the adjustment of warping of a chemically strengthened glass sheet; and of glass sheets producible according to the method is known from DE 10 2013 104 589 A1. Herein a float glass sheet of chemically strengthened glass is disclosed, wherein the glass sheet has a sheet thickness of 0.25 mm to 1.5 mm, wherein the difference of the fictitious temperature in two planes in the glass on the surfaces located on opposite sides of the float glass sheet is less than 7K, preferably less than 5K, wherein the planes are formed always either by one surface side of the float glass sheet or progress within a depth to 50 μm beneath the surface of the surface side and parallel to the surface side. In particular, an approximation of the fictitious temperatures of both surface sides of the float glass sheet with a symmetric temperature/time progression during cooling of the glass ribbon is achieved. The float glass sheet can also be chemically strengthened. The application of additional coating is however not described. It is not described therein that, at the time of chemical strengthening, each side of the float glass has at least one layer of coating.

DE 10 2007 009 786 A1 moreover describes a coated strengthened glass, as well as a method for its production. Here, a glass sheet is provided with an optically effective coating and is chemically strengthened before or after application of the optically effective coating while the glass sheet is stored in a potassium-based medium, so that sodium ions in the glass sheet in regions close to the surface are replaced at least partially with potassium ions. As shown in the example in FIG. 1 however, only symmetrically coated glass sheets are produced. Asymmetrically structured thin glass sheets that are coated on both surface sides and chemically strengthened are not described.

Finally, WO 2011/149694 A1 describes a chemically strengthened glass object, as well as a method to produce same. In this case, a Sol-gel coating is first applied to both surface sides of a glass sheet, followed by an ion exchange. However, in this case symmetrically structured glass sheets are regularly produced.

What is needed in the art is a way to produce asymmetric thin glass sheets which avoids the disadvantages of the current state of the art.

### SUMMARY OF THE INVENTION

The present invention provides a thin glass sheet of asymmetric design that is chemically strengthened on both surface sides, and wherein nevertheless bending or warping of the thin glass sheet is reduced to a minimum or is completely avoided. Moreover, a method is provided with which the thin glass sheet can be produced.

According to an embodiment of the invention, a thin glass sheet is produced that comprises a first and a second surface side, wherein the thin glass sheet is asymmetrically structured in as far as the two surface sides differ from one another. The coating on each of the two surface sides of the thin glass differ from the other surface side in at least one property or characteristic, e.g. each side can be coated with a different coating than the other side. The respective coatings on the two surface sides therefore differ from one another by at least one property or characteristic, which can be selected from: thickness, porosity, number, structure, composition of layer(s) or manufacturing process of the layer(s).

The two surface sides may also differ from one another by more than one property or characteristic. For example, one coating may be present on one surface side, and another coating may be present on the other surface side, or a different number of coating layers may be present on one surface side than on the other surface side, resulting in an asymmetrically coated thin glass sheet.

In an embodiment of the thin glass sheet according to the present invention, both surface sides are chemically strengthened and each respectively show a depth of layer of the alkali ions that are introduced through chemical strengthening, whereby the depth of layer of the first surface side (DoL₁) and the depth of layer of the second surface side (DoL₂) are coordinated with each other in such a way that they are equal or are adjusted on both surface sides.

The depth of layer on the first surface side (DoL₁) and the depth of layer on the second surface side (DoL₂) of the thin glass sheet can be adapted such that the difference in the depths of layers ΔDol:
for silicate glasses is less than or equal to 15%, such as less than or equal to 10%, less than or equal to 7%, less than or equal to 6%, or less than or equal to 5%;
   whereby the %-values refer to the surface side having the lesser depth of layer.

According to another embodiment, the depth of layer on the first surface side (DoL₁) and the depth of layer on the second surface side (DoL₂) of the thin glass sheet are adapted such that the difference in the depths of layers ΔDol:
for soda-lime-silica glasses, crown glasses and borosilicate glasses is less than or equal to 15%, such as less than or equal to 10%, less than or equal to 7%, less than or equal to 6%, or smaller than or equal to 5%;
for alumino-silicate glasses such as alkali-alumino-silicate glasses and lithium-alumino-silicate glasses less than or equal to 10%, such as less than or equal to 5.5%, less than or equal to 4.5%, or smaller than or equal to 3.5%,
   whereby the %-values refer to the surface side having the lesser depth of layer.

This provides for a clear reduction or elimination of bending or warping of a thin glass sheet.

A method to produce an asymmetrically structured thin glass sheet is also an objective of the current invention and can include the steps of:
forming a thin glass sheet from a melt,
placing a layer into, or applying one or several layers onto, a first surface side of the thin glass sheet after completed glass manufacturing process (offline-coating),
simultaneously with coating of the first surface side of the thin glass sheet or afterwards: applying one or several layers onto the second surface side of the thin glass sheet subsequent to the completed glass manufacturing process (offline-coating),
performing chemical strengthening,
optionally (provided the current intermediate product does not constitute an asymmetrically structured thin glass sheet) applying one or several additional layers onto the first and/or second surface side of the thin glass sheet and/or optionally removing of the one or several layers from one of the two surface sides and
obtaining an asymmetrically structured, two-sided coated and two-sided chemically strengthened thin glass sheet; or
forming a thin glass sheet from a melt,
placing a layer into or applying one or several layers onto the first surface side of the thin glass sheet during the glass manufacturing process or immediately after the glass production, before the glass is cut (online-coating),
coating the thin glass sheet with one or several layers onto the second surface side of the thin glass sheet after completed glass manufacturing process (offline-coating),
performing chemical strengthening,
optionally (provided the current intermediate product does not constitute an asymmetrically structured thin glass sheet) applying one or several additional layers onto the first and/or second surface side of the thin glass sheet and/or optionally removing of the one or several layers from one surface side of the thin glass sheet, and
obtaining an asymmetrically structured, two-sided coated and two-sided chemically strengthened thin glass sheet; or
forming a thin glass sheet from a melt,
placing a layer into or applying one or several layers onto the first surface side of the thin glass sheet during the glass manufacturing process or immediately after the glass production, before the glass is cut (online-coating),
placing a layer into or applying one or several layers onto the second surface side of the thin glass sheet during the glass manufacturing process or immediately after the glass production, before the glass is cut (online-coating),
performing chemical strengthening during the glass manufacturing process or immediately after the glass production,
optionally (provided the current intermediate product does not constitute an asymmetrically structured thin glass sheet) applying of one or several additional layers onto the first and/or second surface side of the thin glass sheet and/or optionally removing of the one or several layers from one surface side, and
obtaining an asymmetrically structured, two-sided coated and two-sided chemically strengthened thin glass sheet.

During strengthening, at least one layer can always be present on both surface sides. In other words, at the time of strengthening one or several layers are present on the first surface side and one or several layers are present on the second surface side.

Thus, a method is provided that makes chemical strengthening of a thin glass sheet possible in a number of possible variations, wherein warping or respectively bending of the glass sheet that would be result through strengthening can be reduced or completely prevented, even though the ultimately resulting glass sheet is asymmetrically structured.

In the context of the current invention, the term “asymmetrically structured” means that the two surface sides of the thin glass sheet differ from one another in at least one property or characteristic; for example, one coating may be present on one surface side, and another coating may be present on the other surface side. A different number of coating layers may be present on one surface side than on the other surface side. Moreover, the structuring of the layers can be different between the two surface sides. For example, a different sequence of layers may be used, or the layers on the respective surface sides may have different compositions. The layer(s) on one surface side may be produced with a different manufacturing process than the layer(s) on the other surface side, resulting in different properties, for example a different density of the applied layer. There may also be more than one differentiating characteristic in which the two surface sides distinguish themselves from each other.

The “surface side” of the thin glass sheet refers herein to the glass surface with—where applicable—coating applied thereupon consisting of one or several layers.

In the context of the current invention the term “asymmetrically coated” means that a different number of layers is present on one surface side, compared to the other surface side.

Individual aspects of the current invention are explained further herein.

In one embodiment of a method according to the present invention, a thin glass sheet is initially formed in a first step from a melt wherein the first and second surface side in the first instance are comparable in their chemistry and their structure in the region close to the surface. Methods such as down-draw, overflow fusion or up-draw methods are suitable for the production.

A distinction is made in the method variations of the current invention between layers that were applied online, in other words during the glass manufacturing or forming process, and such layers that were applied offline, in other words after the glass manufacturing process or, respectively, forming, for example after cutting or after edge finishing. In one embodiment the layers are applied onto both surface sides offline, i.e., after completed glass manufacturing process or forming.

On a first surface side of the thin glass sheet, one or several layers are therefore placed after forming into the first surface side or one or several layers are applied onto same which in subsequent chemical strengthening act to inhibit diffusion for the ion exchange. “Placing of a layer into the surface side” means applying doping into the layer, so that no “layer” is placed but rather a change or transformation of the surface side occurs. To simplify matters however, this term also describes a “layer”. These are, for example, diffusions of tin atoms into the surface of a glass, as occurs in regard to the production of float glass. This placement or, respectively, diffusion into the surface side is herein to be understood as “layer”.

In order to counter warping or bending of the thin glass sheet during chemical strengthening, appropriate inhibition of the alkali ion diffusion is created on the second surface side of the thin glass sheet. This is achieved by applying one or several layers onto the second surface side of the thin glass sheet.

The layers on both sides can be placed or, respectively, applied simultaneously. Thus, both sides can be coated simultaneously, for example, in a Sol-Gel immersion process. In this case, both sides are then the same. Or, the layers on both sides are produced successively, in other words one surface is coated first and the other is coated afterwards. For example, the first side is first coated in a Sol-Gel immersion process, whereby the other side is protected, for example, by a film. Naturally, other coating methods are possible, such as the Sol-Gel spray method, spin coating, flame pyrolysis or sputtering. The second side is subsequently coated with the same process, whereby the properties or characteristics of both coatings, such as layer composition, thickness, etc. can vary. Therefore, both surface sides can be coated simultaneously (for example with the Sol-Gel method) or one after the other (for example through sputtering), and the applied coating can be the same or can be different on both surface sides.

According to one embodiment of the invention, the one or several layers on the second surface side can be selected in such a way that they possess properties that are the same or are adjusted to those of the one or several layers on the first surface side. The coating on the second surface side can, for example, have the same thickness, porosity, number of layers, composition and/or structures as the coating on the first surface side.

If the one or several layers on the first and second surface side possess the same or adjusted properties, then the diffusion properties for the alkali ions during chemical strengthening are generally also the same or are adjusted for the first and second surface side. This adjustment of the properties of the coating of the first and second surface side turns out especially well if the coating for both surface sides is selected completely identical and applied parallel on both sides whereby, for example, the coating on the second surface side can be removed again following the chemical strengthening. This is, in particular, a feasible method of obtaining very thin glasses having high-strength properties that are coated and chemically strengthened and have no—or practically no—warping or bending.

According to the present invention, an intermediate product can be provided that is used for chemical strengthening and which thereby produces the same or comparable depth of layers after chemical strengthening. This intermediate product can be structured either symmetrical or asymmetrical.

If the intermediate product is a symmetrically structured thin glass sheet, the properties or characteristics of the two surface sides (of the glass surfaces with the coatings applied thereupon) do not differ or differ as little as possible from each other. A symmetrically structured intermediate product signifies a thin glass sheet that has the same coating on both sides. Chemical strengthening is then implemented and, subsequently, the asymmetrical thin glass sheet is again produced, either through application of additional layers or removal of layers.

Even if the intermediate product is not structured symmetrically, it can nevertheless be possible that the two asymmetrically structured surfaces display the same properties after chemical strengthening. For example, antireflective (AR) coating can be applied in the Sol-Gel method onto one surface side; the second surface side can, for example, be furnished with reflective layers that are applied with the Sol-Gel method (for example Mirona Beamsplitter products by Schott AG). The two coatings differ then among other factors in the thickness of the entire layer arrangement and in the number of layers. However, after chemical strengthening an almost identical depth of layer is achieved for both surface sides. An intermediate product of this type is therefore suitable for the current invention. The discussed examples of coatings are removed after strengthening, so that in the case of the example the intermediate product constitutes the end product.

An additional example for an asymmetrically structured intermediate product that provides equal or comparable depth of layers on both surface sides is when an AR-coating is applied in a Sol-Gel process onto one surface side and a SiO₂ layer is applied in a flame pyrolytic process onto the second surface side in order to achieve a targeted inhibition of the alkali ion diffusion, whereby this layer is generally optically ineffective. This method utilizes chemical vapor deposition (CVD). The two coatings differ from one another, among other factors, in regard to thickness of the entire layer arrangement, the number of layers and the method of application. These coatings are not removed after strengthening. In this case, the intermediate product used for chemical strengthening is already the final product.

The one or several layers that are present on both surface sides prior to chemical strengthening are therefore selected in such a way that the depth of layer of the first surface side (Dol₁) and the depth of layer of the second surface side (DoL₂) are coordinated such that they are the same or are adjusted on both surface sides.

The one or several layers on both surface sides can be selected prior to chemical strengthening such that the difference of the depth of layer ΔDoL is within the aforementioned range.

Numerous possibilities that are known exist to adjust the properties of the second surface side to those of the first surface side, in particular the depths of layers of the alkali ions introduced through chemical strengthening. For example, one or several of the following modifications can be performed.
The chemical composition of the layer(s) can be selected accordingly; influence upon inhibition of the alkali ions can be exercised according to the properties of the selected composition.
The porosity of the layer(s) can be varied. Inhibition in the layer normally becomes less with higher porosity. With lower porosity, inhibition normally increases.
The thickness of the layer(s) can be varied; inhibition normally increases with increasing thickness and decreases with decreasing thickness.
The number of layers can be varied, whereby several layers mean that several boundary surfaces are present; the inhibitory effect becomes greater with increasing number of layers.
The structure of the layers, i.e., their sequence, can be varied.
The coating method can be a contributing factor to producing a layer having greater or lesser density so that the diffusion inhibition for the alkali ions increases or decreases accordingly.

Other modifications of properties are also conceivable.

After coating of the second surface side of the thin glass sheet, chemical strengthening occurs, whereby the ion exchange occurs on both sides through the coating.

According to one embodiment of the present invention, at least one layer is present on both surface sides at the time of strengthening.

Subsequent to chemical strengthening, the one or several layer(s) can again be removed from the first or the second surface side, if required.

The one or several layer(s) on the first and the second surface side may be present in the form of functional layers that provide the desired properties to the thin glass. It is understood that these layers are selected such that they can be subjected to chemical strengthening without the layers being negatively affected. Layers of this type are known from the current state of the art.

The one or several layer(s) that are applied prior to chemical strengthening can be selected from inorganic layers that represent functional layers and which are not vulnerable with respect to the conditions during chemical strengthening. Inorganic layers can be selected from bonding agent layers, optically effective layers such as antireflective, reflective, highly reflective, anti-dazzling and/or anti-glare layers, anti-scratch or scratch resistant layers, antimicrobial layers, conductive layers, cover layers, protective layers such as corrosion resistant layers, abrasion resistant layers, hard or ultra-hard layers, alkali diffusion inhibiting layers and/or colored layers. If required, the one or several layers can be adjusted in such a way that they are not optically visible, so that they can remain on the thin glass sheet without interfering. According to an aspect of the invention, one or several optically effective layers can be selected in the form of antireflective and/or highly reflective layers in combination with a bonding agent layer that may or may not represent part of the optically effective layers.

After chemical strengthening, one or several additional layer(s) can be applied onto the existing layers on one or on both surface sides.

If one or several additional layer(s) are subsequently applied after chemical strengthening, then these can generally be layers that are not stable during chemical strengthening and that cannot be applied in advance. These can include organic layers, in other words layers comprising one or several organic compounds, such as polymer-containing layers such as anti-fingerprint and/or easy-to-clean layers and/or anti-fog layers. Adhesive layers can also be applied to one surface side after the layer or layers on one surface side has/have first been removed.

If strengthening occurs in a tempering oven, the glasses can be cut prior to chemical strengthening provided that the oven dimensions require this. An additional edge finishing on the thin glasses may also be performed.

According to one embodiment of the invention, applying the coating on the first and the second surface side can also occur chronologically reversed, i.e., the second surface side is coated first before the first surface side. Coating of both surface sides can be performed simultaneously or successively.

The optional application of additional layers onto the first and/or second surface side and the optional removal of one of the coatings from one surface side can also occur in chronologically reversed sequence from that described above, i.e., removing the coatings on one of the surface sides occurs first, followed by application of one or several layers on the other surface side.

In another embodiment of a method according to the present invention, a thin glass sheet is initially formed from a melt, wherein in another associated step a layer is placed into the first surface side, in other words into the surface region of the thin glass sheet during the manufacturing process or forming of the thin glass sheet, or immediately thereafter in a continuous process, before the glass is cut. Alternatively, one or several layers may also be applied onto the first surface side of the thin glass sheet during the glass manufacturing process or forming of the thin glass sheet, or immediately thereafter in a continuous process, before the glass is cut. Coating therefore occurs in an online process.

One example for placement of a layer into the first surface side of a thin glass sheet is a thin glass that is produced in the float process. In the float process, tin ions are diffused into the first surface side of the thin glass sheet. These act as network forming and network changing components in the surface region of the glass, so that the alkali ion exchange is reduced during chemical strengthening. A float bath is suitable for formation of such thin glass sheets, whereby the liquid glass melt flows from the melting tank to a liquid tin bath, is formed to a flat thin glass on the tin surface, is cooled and is drawn off in the form of a thin glass sheet. Herein the first surface side of the thin glass is in contact with the tin, whereby tin ions diffuse into the glass surface. Within the scope of the current invention, the doping of the regions of the thin glass that are close to the surface is simply referred to as a “tin layer” or “tin-doped surface layer”.

Thin glass sheets that are produced by the float process have surfaces with manufacturing related different properties. The one surface—generally the side that is on top during the manufacturing process—is in contact with the atmosphere during the float process. The other, opposite side—accordingly the bottom side—is in contact with the tin bath in the float process. This contact with a different media already leads to different properties on both surface sides of the glass sheet. This is an asymmetrically structured thin glass sheet that is, however, not within the scope of the invention since according to the invention only asymmetrically structured thin glass sheets that are coated on both sides should be considered.

In order to compensate for the different properties therefore, one or several layer(s) are subsequently applied (offline) to the second surface side, i.e., to the surface of the finished formed thin glass that is not doped with tin. The difference in the properties, in particular the diffusion inhibition of the alkali ions between the sides, can be relatively small, in particular, if the tin accumulation on the tin side is low, so that, for example, only one layer has to be provided on the second surface side in order to adjust or compensate the strengthening conditions during chemical strengthening. If a thicker layer or thicker layers on the second surface side is/are provided, these can have an adequate porosity in order to not excessively inhibit the diffusion of the alkali ions.

Subsequently, the chemical strengthening occurs through the layers that are disposed on both surface sides. After chemical strengthening, the one or several layer(s) on the first or second surface side can again be removed, if required. Alternatively, one or several additional layers can be applied after chemical strengthening on the first surface side (the tin side) and/or on the second surface side. If the layer or layers on one surface side is/are to be removed, then naturally one or several additional layers can be applied, if required, on only the other surface side.

If a tin layer is present on the first surface side, one or several additional layers can be applied on the opposite second surface side prior to performing chemical strengthening. The one or several additional layers that are applied additionally on the first or second surface side may be applied only to adjust the diffusion properties, in particular the depth of layers on both surface sides and can then be removed again after chemical strengthening. The compensating layers may also not be removed again after strengthening, but remain on the thin glass.

There is also the possibility that instead of, or in addition, to tin, other elements can be added as network forming components into the first surface side during forming. These are, for example, gallium and/or indium ions.

According to another embodiment, an online CVD-coating can be performed on one side in a down-draw process, wherein one or several layers are applied on the first surface side during forming.

The sequence of steps can also be reversed.

Another embodiment of a method according to the present invention is essentially similar to the previously described method, whereby however the layers are produced on both surface sides during the glass manufacturing process or forming, i.e., in an online process. A tin layer can, for example, be produced during the glass manufacturing process, on the first surface side and a layer in a thermal CVD-process on the second surface side, whereby the CVD-process draws its energy from the heat of a float bath, thereby producing a layer (on the air-side of the thin glass). Only one tin layer is then present on the first surface side. An online CVD-coating can, for example, also be performed on both sides in a down-draw process, whereby layers are formed on both sides in an online process. Coating of both surface sides can be performed simultaneously or successively.

Additional aspects of the present invention that are relevant to all described methods, as well as for the thin glass sheet, are explained in further detail herein.

The thin glass sheet is chemically strengthened on both sides in order to provide greater mechanical impact resistance, breaking strength and scratch resistance. Chemical strengthening is performed through an ion exchange as is already known in the current state of the art, wherein according to the invention however, the ion exchange is performed through the coatings that are present on both sides of the glass. Within the concept of the present invention, the introduction of doping into the thin glass sheet, for example tin during manufacture in the float process, is understood, for the sake of simplification, as “coating” or “layer”. The ion exchange of smaller alkali ions, e.g., sodium and/or lithium ions, from the glass with larger alkali metal ions, e.g., potassium, rubidium and/or cesium ions, results in a compressive stress zone or layer that prevents mechanical damage, such as scratching or abrasion, thus making the glass more resistant to damage.

According to one embodiment, strengthening occurs with a thin glass sheet whose two surface sides have at least one layer present; that is one or several layers are present on the first surface side and one or several layers are also present on the second surface side.

The chemical strengthening is performed, for example, through immersion in a potassium based, such as a potassium-nitrate based, salt melt. There is also the possibility of using an aqueous potassium silicate solution, paste or dispersion, as described, for example, in detail in WO 2011/120656.

The ion exchange process can be performed in a salt bath at a temperature between 350 and 500° C. for a duration of 0.5 to 48 hours. If alumino-silicate glasses and boroalumino-silicate glasses or glass-ceramics based thereupon are used, the temperature can be between 400 and 450° C. and the duration between 1 and 8 hours. If soda-lime glass, crown glass or a glass-ceramic based thereupon is used, then the temperatures can be at 390 to 500° C. for a duration between 1 and 24 hours. Borosilicate-glasses or ceramics based on same are treated, for example, at temperatures between 440 and 500° C. for a duration between 4 and 48 hours.

The process of chemical strengthening can be described through the known laws of diffusion. For characterization of chemical strengthening, the surface tension (compressive stress) CS, measured in MPa, and the depth of layers DoL (depth of ion exchanged layers), measured in μm are used. According to the present invention, it was discovered that an adjustment of the diffusion inhibition of the alkali ions during chemical strengthening, and thus a clear reduction or even prevention of warping or bending of the thin glass sheet is achieved due to chemical strengthening, when a balance is achieved on both surface sides of the thin glass of the DoL (depth of ion exchanged layer) of the alkali ions that are present due to chemical strengthening. The “DoL” represents the depth of layers of the alkali ions, generally potassium ions that are present based on chemical strengthening, due to ion exchange in an accordingly coated surface side of the thin glass.

According to the present invention, it was discovered that during chemical strengthening, the ion exchange through one or several layers occurs to a lesser extent than without coating. The layer or layers act like alkali inhibiting layers. If, for example, a glass sheet is coated on only one surface side, i.e., is an asymmetrically coated glass sheet, then this causes the glass sheet to be strengthened differently on each surface side (and to display different DoL) and bends.

The depth of layers (DoL) are the values with which a strengthened glass is characterized. It is dependent upon the selected strengthening durations and temperatures, and also on the glass type. The depths of layers are determined by a photoelastic measurement with measuring device FSM 6000. The measurement is based on the fact that, due to the stresses, optical isotropic glass becomes anisotropic and thus double refractive. This means that the propagation speed of light in the glass depends on the direction of propagation. The thus arising phase shifts between two rays can be measured and converted into the prevailing tensions and the depth of the hardness.

According to the present invention, it has been found that the difference of the depth of layers ΔDoL of both surface sides plays a role in bending of the glasses. “ΔDoL” represents the difference of the depth of layer of the first surface side of the thin glass compared to the depth of layer of the second surface side of the thin glass. According to the invention ΔDoL can be:
for silicate glasses less than or equal to 15%, such as less than or equal to 10%, less than or equal to 7%, less than or equal to 6%, or smaller than or equal to 5%;
whereby the %-values refer to the surface side having the lesser depth of layer.

According to an additional embodiment, ΔDoL is selected as follows:
for soda-lime-silica glasses, crown glasses and borosilicate glasses less than or equal to 15%, such as less than or equal to 10%, less than or equal to 7%, than or equal to 6%, or smaller than or equal to 5%;
for alumino-silicate glasses such as alkali-alumino-silicate and lithium-alumino-silicate glasses less than or equal to 10%, such as less than or equal to 5.5%, less than or equal to 4.5%, or smaller than or equal to 3.5%,
whereby the %-values refer to the surface side having the lesser depth of layer.

In other words, the DoL on the second surface side is adjusted due to the selection of the properties of the one or several layers applied upon it in such a way that—in the case of a soda-lime-silica glass—it deviates 15% maximum from the DoL on the first surface side, such as 10% maximum, 7% maximum, 6% maximum or 5% maximum.

The difference in the depth of layer (DoL) ΔDoL between the first surface side (DoL₁) and the second surface side (DoL₂) can be:
for soda-lime-silica glasses, crown glasses and borosilicate glasses less than 1.5 μm such as less than or equal to 1.0 μm or less than or equal to 0.5 μm;
for alumino-silicate glasses such as alkali-alumino-silicate glasses and lithium-alumino-silicate glasses less than or equal to 3 μm, such as less than or equal to 2.5 μm, or less than or equal to 2.0 μm.

By providing one or several layers on the second surface side of the thin glass sheet, the ion exchange can be regulated in such a way that a balance results in the strengthening conditions. Thus depths of layers result on both sides of the thin glass sheet that are as balanced as possible. Bending or warping of the chemically strengthened thin glass sheet can hereby be reduced to a minimum or can be completely prevented. The surface tension and depth of layer are values that depend on the selected strengthening durations and temperatures, and in particular on the selected glass type. Aluminum-containing glasses, for example Xensation® by Schott AG or Gorilla-Glas® by Corning Inc. tend to be able to be more effectively chemically strengthened. In other words, it is possible with these products to achieve greater depths of layers and surface tensions, compared to soda-lime-silica glasses or crown glasses (for example B270i, distributed by Schott AG). Therefore, distinctions were made in the teaching between the individual glass types.

According to one embodiment of the present invention, it is also possible to further equip the thin glass sheet with antimicrobial properties. Surprisingly, chemical strengthening can be combined with the provision of antimicrobial properties without adversely affecting other functionalities of the coated glass surface. The antimicrobial properties can be obtained in that chemical strengthening is replaced in the aforementioned method variations by:
performing an ion exchange process with the coated thin glass sheet in a salt bath.
(1) wherein the salt bath contains a mixture of potassium, rubidium and/or cesium salt with one or several metal salts with antimicrobial effect, which can be selected from the group consisting of silver-, copper-, cadmium-, zinc-, iron-, tin-, cobalt-, cerium-, antimony-, selenium-, chromium-, magnesium- and/or nickel-salts in order to provide the thin glass sheet with antimicrobial properties and at the same time to chemically strengthen the glass;
   or
(2) wherein in a first step a first salt bath contains potassium, rubidium and/or cesium salt, and in a second step a second salt bath contains a mixture of potassium, rubidium and/or cesium salt with one or several metal salts with antimicrobial effect, which can be selected from the group consisting of silver-, copper-cadmium-, zinc-, iron-, tin-, cobalt-, cerium-, antimony-, selenium-, chromium-, magnesium- and/or nickel-salts in order to provide the thin glass sheet with antimicrobial properties and at the same time to chemically strengthen the glass.

The ion exchange process (1) and the first step in the ion exchange process (2) can thereby be performed in a salt bath at a temperature between 350 and 500° C. and for a duration of between 0.5 and 48 hours. The second step in the ion exchange process (2) can be performed in a salt bath at a temperature between 400 and 500° C. and for a duration of between 0.25 and 2 hours. An amount of antimicrobially effective metal salts in the salt bath can be in the range of 0.01 to 2 weight-%, such as 0.01 to 0.5 weight-%.

According to the present invention, it is therefore possible to reduce distortion or bending of the substrate or compensate for it completely. By adjusting or balancing the depth of layer of the first surface side (DoL₁) and the depth of layer of the second surface side (DoL₂) of the thin glass sheet, warping or bending of the substrate can at least be diminished to such an extent that it is within the predefined tolerances. Warping or bending within the scope of the current invention can be tolerated if the thin glass sheet displays a maximum deviation (warp) from flatness—measured along the diagonal along the entire length of the sheet surface, in particular along a length of 150 mm—of less than 300 μm, such as less than 250 μm or less than 200 μm.

The thin glass sheet formed according to the present invention therefore has a high planarity that is often also referred to as planicity. In the sense of the present invention, this is understood to mean that the thin glass sheet in an unstressed condition in which it is laying on a flat, ideally planar base and is subjected only to gravity, adopts a geometric shape whereby the free surface of the thin glass sheet deviates hardly or not at all from an ideally planar surface that progresses parallel or plane-parallel to the surface of the thin glass sheet. Thus, when a thin glass sheet is placed on an ideally plane base, the sheet rests on its entire surface. In other words, a partial lifting of certain regions of the sheet does not occur or occurs only within the predetermined tolerances.

Therefore, all points that are located on the surface of the glass sheet facing away from the base are within a predetermined tolerance range. “Planarity” therefore is understood to be a spatial arrangement of points on the surface of the thin glass sheet that do not exceed a predetermined distance from an ideal flat plane that is positioned parallel to the surface of the glass sheet. This deviation of the points on the surface from the ideal flat plane is also referred to as deviation from the flatness (warp). Measurement can be performed along a diagonal on the surface. Measurement can occur by measuring several points located closely to one another along the diagonal, whereby the dimensional distance of a measuring point on the surface is determined by an ideal flat plane parallel to the surface. Measurement is hereby taken on the diagonal length, in other words along the length of the diagonal.

The thin glass sheet therefore meets the high requirements for the use as a cover glass for smart phones or touch panels due to the adjusted or balanced depths of layers, due to which deformation of the glass sheet is reduced to an extent that is within the predefined tolerances, or due to which the deformation is ideally completely compensated.

Chemical strengthening is especially suitable for providing straight thinner glass sheets with higher stability. The thin glass substrate thus can have a thickness in the range of less than or equal to 3 mm, such as less than or equal to 2 mm. Lesser thicknesses are also possible. For the use in small size display glasses, in particular touch panels or touch screens the substrate can have a thickness of less than or equal to 1.1 mm. Exemplary thin glasses or ultra-thin glasses are marketed by Schott AG, Mainz under the designations D263®, B270®, B270®i Borofloat®, Xensation® Cover, Xensation® Cover 3D, Xensation® Sound, Xensation® Touch, etc.; other glasses are also suitable, for example those that are offered by Pilkington under the trade name Microfloat®.

The present invention is of particular importance with thin glasses or ultra-thin glasses where a deflection of the surface has especially serious consequences and frequently results in a glass breakage, for example where glasses need to have high planarity based on the demands of a specific application. Bending of thin glass occurs also when the glass dimensions are very large, so that in spite of a somewhat greater thickness an absolute deflection results, for example during cutting, thus interfering with the application.

The optional removal of the one or several layers from one surface side after chemical strengthening can be performed in such a way that the DoL and the compressive pressure zone that results from chemical strengthening is altered as little as possible, i.e., is essentially maintained. The removal of the one or several layer(s) can, for example, occur through removal of the layer by polishing, turning or washing. This can provide an asymmetrically structured thin glass substrate that, in spite of the coating that is present, displays practically no undesirable warping.

The one or several layers that are placed in the thin glass sheet or onto the thin glass sheet prior to chemical strengthening are optional layers, which however may not be impaired or even destroyed by chemical strengthening. These can be inorganic layers, i.e., layers that comprise or consist of one or several inorganic compounds. Generally organic layers are unsuitable, that is layers that comprise or consist of one or several organic compounds such as polymer-containing layers, for example anti-fingerprint, easy-to-clean and anti-fog layers.

The layers involved may also be process related layers, i.e., layers that are created based on the manufacturing process, for example a tin layer in float glass production.

The one or several layers can be selected in order to provide the thin glass sheet with one or several functions, with such layers being known. Examples are bonding agent layers, optically effective layers such as antireflective, reflective, highly reflective, anti-dazzling and/or anti-glare layers, anti-scratch or scratch resistant layers, antimicrobial layers, conductive layers, cover layers, protective layers such as corrosion resistant layers, abrasion resistant layers, hard or ultra-hard layers, alkali diffusion inhibiting layers and/or colored layers.

According to one embodiment of the present invention, an antireflective (AR) coating consisting of one or several layers is applied onto the first or second surface side of the thin glass sheet prior to chemical strengthening. This is described further herein as one possible embodiment of the invention, without however limiting the invention thereto.

According to one embodiment of the invention, an antireflective coating consists of one or at least two layers. The one layer or the uppermost layer of the at least two layers can be a bonding agent layer that can interact with an additional layer that is to be applied thereupon, for example an anti-fog-, anti-fingerprint- and/or easy-to-clean coating, resulting in long-term stability of the anti-fog-, anti-fingerprint- and/or easy-to-clean coating. The bonding agent layer is a layer that causes improved adhesion between the layer below and above it. It interacts with an applied coating in such a way that due to a chemical, in particular a covalent bond between the bonding agent layer of the thin glass sheet and the coating applied thereupon, the long term stability of the coating is increased.

The bonding agent layer can be the uppermost layer of the antireflective coating and have a low refractive index.

If the antireflective coating represents a single layer that is in the form of a bonding agent layer, the refractive index can be in the range of 1.22 to 1.44, such as 1.28 to 1.44. In the case of an AR-coating that is structured of several layers and whereby the uppermost layer is a bonding agent layer, the refractive index of the uppermost layer can be in the range of 1.22 to 1.70, such as 1.28 to 1.60 or 1.28 to 1.56.

The antireflective coating can be structured in such a way that an incomplete antireflective coating is present and only through the presence of a bonding agent layer and, if required, an additional coating, for example anti-fog-, anti-fingerprint- and/or easy-to-clean coating a complete antireflective coating is provided.

In accordance with an additional embodiment of the present invention, the antireflective coating consists of three or more layers with alternating medium, high and low refractive indices. In this case too, the uppermost layer can be a bonding agent layer having a low refractive index.

According to an additional embodiment of the present invention, the antireflective coating consists of two or more layers with alternating low and high refractive index. In this case too, the uppermost layer can be a bonding agent layer having a low refractive index.

At least one layer of the antireflective coating, such as the uppermost or bonding agent layer, can be divided into sublayers, whereby one or several intermediate layers can be present. The one or several intermediate layers then can have practically the same refractive index as the sublayers.

According to one embodiment of the present invention, the bonding agent layer is an oxide that comprises at least one of the elements of the primary groups II to V and/or subgroups II to V, such as at least one oxide selected from silicon, titanium, aluminum, magnesium, tantalum, niobium, boron, hafnium, indium, germanium, tin, phosphorus, vanadium, cerium, zinc and/or zirconium, or one or several fluorine compounds, for example magnesium fluoride (MgF₂) or calcium fluoride (CaF₂) or a mixed oxide, such as a silicon mixed oxide that contains aluminum-, tin-, magnesium-, phosphorus-, cerium-, zircon-, titanium, cesium-, barium-, strontium-, niobium-, zinc-, boric oxide and optional magnesium fluoride. The bonding agent layer can then develop its function to a special degree if it represents a mixed oxide. In the sense of the current invention, “silicon oxide” is understood to include all oxides between silicon monoxide and silicon dioxide. Such silicon according to the context of the present invention is understood to be a metal or a semi-metal. Silicon mixed oxide is a mixture of a silicon oxide with an oxide of at least another element, that can be homogeneous or non-homogeneous, stoichiometric or non-stoichiometric.

The bonding agent layer can have a thickness of greater than 1 mm, such as greater than 10 mm or greater than 20 mm.

In principle, any coating can be used as an antireflective coating including a bonding agent layer. An antireflective coating can be applied by printing technology, spray technology or vapor separation technology. Exemplary coatings are a liquid phase coating or a Sol-Gel coating. The antireflective coating that can comprise or consist of the bonding agent layer applied by CVD-technology, for example by PECVD, PICVD, low pressure CVD or gas phase separation at atmospheric pressure (AVD, atomic vapor deposition; ALD atomic layer deposition). The antireflective coating can also be applied by PVD technology, for example sputtering, thermal evaporation, laser beam- or electron beam- or arc-evaporation. The bonding agent layer can alternatively also be deposited by flame pyrolysis technology. The bonding agent layer and the other layers of the antireflective coating can alternatively be produced by a combination of the various processes.

An example of a Sol-Gel method for producing an antireflective coating is described below.

First, the surface that is to be coated can be cleaned. Cleaning of glass- or glass-ceramic substrates with fluids is a widely known process. A multitude of cleaning fluids is thereby used, such as demineralized water or aqueous systems, such as diluted alkali-solutions (pH>9) and acids, detergent solutions or non-aqueous solvents, for example alcohols or ketones.

The thin glass sheet can be activated prior to coating. Activation processes include, for example, oxidation, corona discharge, flame treatment, UV-treatment, plasma activation and/or mechanical methods such as roughening, sand blasting and also plasma treatments or other treatments of the glass surface for activation with an acid and/or lye.

One exemplary Sol-Gel method uses the implementation of organometallic raw materials in a dissolved state to form the layers. A metal-oxide network structure is created as a result of a controlled hydrolysis and condensation reaction of the organometallic raw materials, i.e., a structure in which metal atoms are connected with one another through oxygen atoms, at the same time eliminating the reaction products, such as alcohol and water hydrolysis reaction can be accelerated through addition of catalysts.

The inorganic Sol-Gel-material from which the Sol-Gel layers are produced can be a condensate, in particular one comprising one or several hydrolysable and condensable or condensed silicon hydrides and/or metal-alkoxides, such as Si, Ti, Zr, Al, Nb, Hf, Ge, B, Sn and/or Zn. The groups that are cross-linked in the Sol-Gel method by inorganic hydrolysis and/or condensation can, for example, be one or more of the following functional groups: TiR₄, ZrR₄, SiR₄, AIR₃, TiR₃(OR), TiR₂(OR)₂, ZrR₂(OR)₂, ZrR₃(OR), SiR₃(OR), SiR₂(OR)₂, TiR(OR)₃, ZrR(OR)₃, AIR₂(OR), AIR(OR)₂, Ti(OR)₄, Zr(OR)₄, Al(OR)₃, Si(OR)₄, SiR(OR)₃ and/or Si₂(OR)₆. The OR group may, for example, be: alkoxy, methoxy, ethoxy, n-propoxy, isopropoxy, butoxy, isopropoxyethoxy, methoxypropoxy, phenoxy, acetoxy, propionyloxy, ethanolamine, diethanolamine, triethanolamine, methacryloxypropyl, acrylate, methylacrylate, acetylacetone, ethylacetoacetate, ethoxy-acetate, methoxy-acetate, methoxyethoxy-acetate and/or methoxyethoxyethoxy acetate. The remainder R may, for example, be: Cl, Br, F, methyl, ethyl, phenyl, n-propyl, butyl, allyl, vinyl, glycidylpropyl, methacryloyloxypropyl, amino-propyl and/or fluoroctyl. A common characteristic of all Sol-Gel reactions is that the molecular-dispersed precursors are subject to a hydrolysis-condensation and polymerization reactions in order to form particular dispersed or colloidal systems. The “primary particles” that are initially formed can continue to grow, subject to the selected conditions, and can combine in order to form clusters or can form linear chains. The resulting units lead to microstructures that are formed due to the removal of the solvent. In an ideal situation, the material can be completely condensed, but in reality a degree of porosity often remains; in some cases, even considerable porosity remains. The chemical conditions during Sol-processing have a critical influence over the properties of the Sol-Gel-coating, as described in P. Löbmann, “Sol-Gel-Coatings”, Advanced Training Course 2003 “Surface Processing of Glass”, Hüttentechnische Vereinigung der deutschen Glasindustrie.

To date, the Si raw materials are very closely examined. In this regard, reference is made to C. Brinker, G. Scherer, “Sol-Gel-Science—The Physics and Chemistry of Sol-Gel Processing (Academic Press, Boston 1990), R. Iller, The Chemistry of Silica (Wiley, New York, 1979). The Si-raw materials that are most often used are silicon-alkoxides Si(OR)₄, that hydrolyze with the addition of water. Under acidic condition, linear aggregates can be formed. Under alkaline conditions, the silicon-alkoxides react to form a higher degree of cross-linked “globular” particles. The Sol-Gel coatings include pre-condensed particles and clusters.

To produce a silicon oxide dipping solution for the thin glass sheet according to the current invention, the dipping solution can be produced as follows: the silicon starting compound(s) is/are dissolved in an organic solvent. Any organic solvents can be used as solvents that dissolve the silicon starting material(s) and that are in a position to dissolve a sufficient volume of water that is necessary for the hydrolysis of the silicon starting compounds. Suitable solvents are for example, toluene, cyclohexane or acetone, or C₁₋₆ alcohols. Examples of C₁₋₆ alcohols are methanol, ethanol, propanol, butanol, pentanol, hexanol or isomers thereof. It is useful to use low alcohols, such as methanol and ethanol, since these are easy to handle and possess a relatively low vapor pressure.

The silicon starting compound that is used is in particular a C₁₋₄-alkyl ester of a silicic acid, that is silicic acid methyl ester, -ethyl ester, -propyl ester or -butyl ester.

The concentration of the silicon starting compound in the organic solvent is generally around 0.05 to 1 mol/liter. For hydrolysis of the silicon staring compound in the described example, this solution is mixed with 0.05 to 12 weight-% water, such as distilled water, and with 0.01 to 7 weight-% of an acid catalyst. For this purpose, organic acids can be added, such as acetic acid, methoxy acetic acid, polyether carbonic acid, for example ethoxyethoxy acetic acid, citric acid, para-toluene sulfonic acid, lactic acid, methacrylic acid or acrylic acid or mineral acids, such as HNO₃, HCI or H₂SO₄.

The pH-value of the solution can be approximately less than or equal to 3. If the solution is not acidic enough (pH above 3) there is a risk that the poly-condensates/clusters become too large. If the solution becomes too acidic there is a risk that it gels.

In an additional embodiment of the present invention, the solution can be produced in two steps. The first step occurs as described above. This solution is then left to mature. The maturing time is achieved in that the matured solution is diluted with additional solvents and/or maturing is interrupted by changing the pH value of the solution into the strongly acidic range, such as a pH range of 1.5 to 2.5. Moving the pH value into the strongly acid range can be accomplished through addition of an inorganic acid, such as through addition of a hydrochloric acid, nitric acid, sulfuric acid or phosphoric acid or any organic acid, such as oxalic acid or similar. The strong acid can be added in an organic solvent, such as in the solvent in which the silicon starting compound is already present in a dissolved state. It is herein also possible to add the acid in a sufficient quantity together with the solvent, such as in an alcoholic solution, so that the dilution of the starting solution and the interruption of the maturing process occur in one step.

The Sol-Gel coatings comprise pre-condensed particles and clusters that may have different structures. These structures can be determined by use of scattered light experiments. By means of process parameters, such as temperature, rate of addition, agitation speed, but in particular pH value, it is possible that the structures are produced in the brines. It has become evident that use of small silicon oxide-poly-condensates/clusters with a diameter of ≦20 nm, such as ≦4 nm, or in the range of 1 to 2 nm facilitates production of immersion-layers that are more densely packed than conventional silicon oxide layers. This leads, for example, to an improvement of the chemical resistance of the layer.

An additional improvement of the chemical resistance and the function as a bonding agent layer is achieved in that small amounts of additives or several additives are added to the solution that are homogeneously preset in the solution and also distributed in the subsequent layer, forming a mixed oxide. Suitable additives are hydrolysable or dissociating inorganic salts, possibly containing crystallization water, selected from the salts of tin, aluminum, phosphorus, boron, cerium, zircon, titanium, cesium, barium, strontium, niobium and/or magnesium. Examples are SnCl₄, SnCl₂, AlCl₃, Al(NO₃)₃, Mg(NO₃)₂, MgCl₂, MgSO₄, TiCl₄, ZrCl₄, CeCl₃, Ce(NO₃)₃, and similar. These inorganic salts can be used in aqueous form as well as with crystallization water.

According to an additional embodiment of the present invention, the used additive(s) can be selected from one or several metal-alkoxides of zinc, aluminum, phosphorus, boron, cerium, zircon, titanium, cesium, barium, strontium, niobium and/or magnesium. Also suitable are phosphoric acid esters such as phosphoric acid methyl ester or -ethyl ester, phosphoric halides such as chloride and bromide, boron acid ester such as ethyl-, methyl-. Butyl- or propyl ester, boron acid anhydride, BBr₃, BCI₃, magnesium methylate or -ethylate or similar.

According to an additional embodiment of the present invention, the additives may also be selected as inorganic fluorides, for example MgF₂, CaF₂, etc., that can be in the form of nanoparticles <200 nm.

Additives can be used when the antireflective coating or parts of the antireflective coating are present as Sol-Gel coating in the form of a bonding agent layer.

This one or several additive(s) can be added in a concentration of approximately 0.5 to 20 weight-%, calculated as oxide (for example fluoride), based on the silicon content of the solution, calculated as SiO₂. The addition or additions can also be used in combinations.

If the immersion solution is stored or otherwise used over a longer time period, it can be useful if this solution is stabilized through the addition of one or several complexing agents. These complexing agents should be soluble in the immersion solution and can be consistent with the solvent of the immersion solution.

Complexing agents that can be used include, for example, ethyl acetoacetate; 2, 3-pentandione (acetylacetone); 3,5 heptandione; 4,6 nonandione; 3-methyl-2,4-pentandione; 2-methylacetylacetone, triethanolamine; diethanolamine; ethanolamine; 1,3 propandiol; 1,5-pentandiol; carbonic acid such as acetic acid; propionic acid; ethoxy-acetic acid; methoxy-acetic acid; polyether-carbonic acids (for example ethoxyethoxy-acetic acid); citric acid; lactic acid; methyl-acrylic acid and acrylic acid and similar.

The molar ratio of complexing agents relative to metalloid oxide precursors and/or metal oxide precursors can be in the range of 0.1 to 5.

In one embodiment, the thin glass sheet is pulled from the solution at a target speed of approximately 50-1500 mm/min., such as 200-1000 mm/min. or 300-1000 mm/min., whereby the moisture content of the ambient air is between approximately 4 g/m² and approximately 12 g/m², such as approximately 8 g/m².

The immersion coated layer can be dried after application in order to obtain greater mechanical strength. Drying can, for example, be performed in a high-temperature furnace within a broad temperature range. Drying times are typically a few minutes at temperatures in the range of 100-200° C.

The formation of the applied layer occurs in one high temperature step to burn off the organic components of the gel. In order to finally form the mixed oxide layer, the silicon mixed oxide layer that may, for example, act as bonding agent layer, can be heated below the softening temperature of the glass or glass-ceramic material, such as at temperatures of less than 550° C., such as between 350 and 500° C. or between 400 and 500° C. It is also possible to use temperatures of higher than 550° C., however the time period should then be selected to be relatively short, so that no deformation of the glass substrate occurs (depending on the thickness of the glass substrate). Generally, such temperatures do not result in additional improvement of the adhesion strength of the layer.

The combination of thicknesses and refractive indices of thin layers allows for a defined reflection and transmission of a glass sheet. For example, MIRONA® is a known, two-sided coated mineral glass that, due to its optical interference layer, allows a defined reflection and transmission. Also known is, for example, MIRONA®Beamsplitter. This is a glass that is provided on one side with an anti-reflective coating and on the other side with a highly reflective coating. A defined reflection and transmission with almost no interfering double reflection is made possible. Both coatings are applied with Sol-Gel.

The one or several layers that can be applied onto the thin glass sheet after chemical strengthening are generally layers that cannot be applied prior to chemical strengthening, because they are not stable under the process conditions of chemical strengthening. These are, for example, organic layers, that is layers that comprise or consist of one or several organic compounds, such as polymer-containing layers, for anti-fingerprint and/or easy-to-clean layers and/or anti-fog layers.

This means that different layers with different functions can be combined with each other on the thin glass sheet, provided the functions do not negatively impact each other. The thin glass sheet can be coated on one or on both sides and the coating(s) can have one or several layers. For example, an antireflective layer can be combined with an anti-dazzling or anti-glare layer. An anti-reflective coating can also be combined with an anti-fog, anti-fingerprint and/or easy-to-clean coating applied thereupon. In addition, one or several bonding agent layers can be provided as intermediate layers, in particular to increase long-term durability.

An anti-fog layer is a special surface treatment that is intended to prevent misting or condensation through the effect of water vapor. Anti-fog or also anti-misting coatings are known, for example, for transparent visors or motor cycle helmets, protective safety glasses or swim goggles, in automobile windshields, headlight glazing as well as in aircraft construction, in optical devices and viewing windows for monitoring purposes in industrial facilities. For example, so-called wetting agents in the form of sprays or fluids are used, that cause the water vapor to precipitate during condensation as a clear transparent film, thus preventing the glass from becoming almost or totally opaque due to water vapor condensation. It is also known to provide an anti-fog layer by embedding silicon-oxide nanoparticles into a polymeric film. An anti-fog coating is typically a clear transparent layer having a thickness of few micrometers that do not substantially alter the optical properties.

According to one embodiment, an anti-fingerprint (AF) coating is applied onto an already existing coating consisting of one or several layers, such as in the form of an AF-coating onto one surface side of the thin glass sheet. This is described further herein as a possible embodiment of the present invention.

According to one embodiment of the present invention, the chemically strengthened coated glass sheet can be provided with an AF-coating that can also be referred to as easy-to-clean coating or as amphiphobic coating. According to the present invention, the term “anti-fingerprint coating” should be widely understood and should include any coating consisting of one or several layers that provide the desired dirt-repelling properties and/or offer easy cleanability.

An AF-coating has hydrophobic and oleophobic, that is amphiphobic properties, such that wetting of the surface through water and oils is reduced to a minimum. The wetting property of a surface having an AF-coating must therefore be such that the surface is hydrophobic—in other words that the angle of contact between surface and water can be greater than 90°—as well as oleophobic—in other words that the contact angle between surface and oil can be greater than 50°.

The AF-coating can be a surface layer, including silane that contains the alkyl and/or fluoroalkyl groups, for example 3,3,3-trifluoropropyltrimethoxysilane or pentyltriethoxysilane.

The AF-coating can also be a surface layer on a fluorine base that is based on compounds with hydrocarbon groups, whereby the C—H compound is partially essentially completely replaced by C—F compounds. Such compounds can be perfluorohydrocarbons with the formula, for example, of (R_{F})ₙSiX₄₋ₙ, whereby RF represents a C₁- to C₂₂-alkylperfluorohydrocarbon or -alkylperfluoropolyether, such as C₁- to C₁₀-alkylperfluorohydrocarbon or -alkylperfluoropolyether, where n is an integer from 1 to 3, X is a hydrolysable group such as halogen or an alkoxy group, and R, for example, represents a linear or a branched hydrocarbon with 1 to 6 carbon atoms. In this case, the hydrolysable group X can, for example, react with a terminal OH-group of the coating of the glass substrate, thus binding to same by creating a covalent bond. Perfluorohydrocarbons can be used to reduce the surface energy because of the low polarity of the terminal fluoric surface conditions.

The AF coating can, for example, also be derived from a mono-layer of a molecular chain with fluorine end groups, a fluoropolymer coating or from silicon oxide soot particles that were previously provided with fluorine end groups or were treated with same.

AF coatings are described, for example, in DE 19848591, EP 0 844 265, US 210/0279068, US 2010/0285272, US 2009/0197048 and WO 2012/163947, which are incorporated herein by reference. Known AF-coatings are, for example, products on the basis of perfluoropolyether and the designation “Fluorolink®PFPE”, such as “Fluorolink® S 10” by the Solvay Solexis company, or also “Optool™ DSX” or Optool™AES4-E” by Daikin Industries LTD, “Hymocer® EKG 6000N” by ETC Products GmbH of fluorosilanes under the designation “FSD” such as “FSD 2500” or FSD 4500” by Cytonix LLC or easy-clean coating “ECC” products such as “ECC 3000” or “ECC 4000” by 3M Germany GmbH. These are layers that are applied in liquid form. AF-coatings, for example nanolayer systems that are applied by physical vapor deposition, are offered for example by Cotec GmbH under the designation “DURALON Ultra Tec”.

The coating may be applied to the surface by immersion, vapor coating, spraying or application with a roll or cylinder or a doctor blade, through thermal vacuum deposition or sputtering, or through liquid phase methods such as spraying, immersion coating, printing, roll-on, spin-coating or other suitable methods. After the coating has been applied, it is hardened at a suitable temperature for a suitable period of time.

The water contact angle of the AF-coating can be >90°, such as >100° or >110°.

According to the present invention, it has been found that the application of an AF-layer onto an AR-coating regularly leads to an improvement in the abrasion resistance of the entire coating system.

In the previously described method variations, the layers can be applied with any desired coating method. In principle, any method with which homogenous layers can be applied to large surfaces is suitable as coating method, such as CVD-coating (application of layers through chemical vapor deposition) such as thermal or plasma-CVD, for example PECVD, PICVD, low pressure-CVD or chemical vapor deposition at atmospheric pressure; PVD-coating (application of layers through physical vapor deposition), for example sputtering, thermal evaporation or flame pyrolysis, spray pyrolysis, laser beam- or electron beam- or arc-evaporation; or liquid phase coating, for example Sol-Gel coating. In the latter, the layer can be applied onto the surface by immersion, vapor coating, spraying, printing, application with a roll, in a wipe application, a rolling and doctoring method and/or in a blade coating or screen printing method, or another suitable method.

Particularly economical control methods which control the amount of the applied coating volume as precisely as possible are, for example, immersion coating, spray coating, CVD-method such as thermal or plasma-CVD coating, PVD method such as sputtering, or liquid phase coating, in particular a Sol-Gel method. An additional economical method for the application of a coating is flame pyrolysis.

There is also the possibility to combine various production methods, such as Sol-Gel application, PVD, CVD. This can be particularly useful with multi-layer, optically effective coatings.

For the production of thin oxide layers from organic solutions that are well known, reference is made to H. Schröder, Physics of Thin Films 5, Academic Press New York and London (1967, Pages 87-141) or also to U.S. Pat. No. 4,568,578 the disclosure of which is incorporated herein by reference. Layers that balance the ΔDoL and reduce the sodium diffusion can be applied by a PVD- or CVD method. Flame-coating, often also referred to as flame pyrolytic coating is a method for deposition of functional thin layers at atmospheric pressure. The method belongs to the group of the chemical vapor deposition (CVD). Large areas can also be provided with a dense coating with the flame-pyrolysis method.

As glass for the thin glass sheet, siliceous glasses can be used according to the present invention. Siliceous glasses are glasses containing silicate. Examples of such glasses are soda-lime-silica glass, crown glass, borosilicate glass, alumino-silicate glass or lithium-alumino-silicate glass. A glass-ceramic based on these glasses can also be use.

The “thin glass” or the “thin glass sheet” described within the scope of the current invention may also refer to a thin glass ceramic or thin glass ceramic sheet.

Siliceous glasses can be, for example, glasses that have the following glass composition (in weight-%):

| | |
|---|---|
| SiO₂ | 10-90 |
| AI₂O₃ | 0-40 |
| B₂O₃ | 0-80 |
| Na₂O | 1-30 |
| K₂O | 0-30 |
| CoO | 0-20 |
| NiO | 0-20 |
| Ni₂O₃ | 0-20 |
| MnO | 0-20 |
| CaO | 0-40 |
| BaO | 0-60 |
| ZnO | 0-40 |
| ZrO₂ | 0-10 |
| MnO₂ | 0-10 |
| CeO | 0-3 |
| SnO₂ | 0-2 |
| Sb₂O₃ | 0-2 |
| TiO₂ | 0-40 |
| P₂O₅ | 0-70 |
| MgO | 0-40 |
| SrO | 0-60 |
| Li₂O | 0-30 |
| Li₂O + Na₂O + K₂O | 1-30 |
| SiO₂ + B₂O₃ + P₂O₅ | 10-90 |
| Nd₂O₅ | 0-20 |
| V₂O₅ | 0-50 |
| Bi₂O₃ | 0-50 |
| SO₃ | 0-50 |
| SnO | 0-70, |

whereby the content SiO₂+P₂O₅+B₂O₃ 10-90 is weight-%

One exemplary soda-lime-silica glass can have the following glass composition (in weight-%):

| | |
|---|---|
| SiO₂ | 40-80 |
| Al₂O₃ | 0-6 |
| B₂O₃ | 0-5 |
| Sum Li₂O + Na₂O + K₂O | 5-30 |
| Sum MgO + CaO + SrO + BaO + ZnO | 3-30 |
| Sum TiO₂ + ZrO₂ | 0-7 |
| P₂O₅ | 0-2 |

One exemplary crown glass can have the following glass composition (in weight-%):

| | |
|---|---|
| SiO₂ | 52-80 |
| Al₂O₃ | 0-15 |
| B₂O₃ | 0-14 |
| Na₂O | 2-16 |
| K₂O | 5-25 |
| MgO | 0-6 |
| CaO | 0-14 |
| ZrO₂ | 0-8 |
| ZnO | 0-6 |
| TiO₂ | 0-5 |
| Sum SrO + BaO | 0-15 |
| PbO | 0-25 |

One exemplary borosilicate glass can have the following glass composition (in weight-%):

| | |
|---|---|
| SiO₂ | 60-85 |
| Al₂O₃ | 1-10 |
| B₂O₃ | 5-20 |
| Sum Li₂O + Na₂O + K₂O | 2-16 |
| Sum MgO + CaO + SrO + BaO + ZnO | 0-15 |
| Sum TiO₂ + ZrO₂ | 0-5 |
| P₂O₅ | 0-2 |

One exemplary alkali-alumino silicate glass can have the following glass composition (in weight-%):

| | |
|---|---|
| SiO₂ | 40-75 |
| Al₂O₃ | 10-30 |
| B₂O₃ | 0-20 |
| Sum Li₂O + Na₂O + K₂O | 4-30 |
| Sum MgO + CaO + SrO + BaO + ZnO | 0-15 |
| Sum TiO₂ + ZrO₂ | 0-15 |
| P₂O₅ | 0-10 |

One exemplary lithium-alumino silicate glass can have the following glass composition (in weight-%):

| | |
|---|---|
| SiO₂ | 55-69 |
| AI₂O₃ | 18-25 |
| Li₂O | 3-5 |
| Sum Na₂O + K₂O | 0-30 |
| Sum MgO + CaO + SrO + BaO | 0-5 |
| ZnO | 0-4 |
| TiO₂ | 0-5 |
| ZrO₂ | 0-3 |
| Sum TiO₂ + ZrO₂ + SnO₂ | 2-6 |
| P₂O₅ | 0-8 |
| F | 0-1 |
| B₂O₃ | 0-2 |

One exemplary alumino silicate glass with low alkali content can have the following glass composition (in weight-%):

| | |
|---|---|
| SiO₂ | 50-75 |
| AI₂O₃ | 7-25 |
| B₂O₃ | 0-20 |
| Sum Li₂O + Na₂O + K₂O | 1-4 |
| Sum MgO + CaO + SrO + BaO + ZnO | 5-25 |
| Sum TiO₂ + ZrO₂ | 0-10 |
| P₂O₅ | 0-5 |

If required, the glass compositions may contain additives of coloring oxides, i.e. Nd₂O₃, Fe₂O₃, CoO, NiO, V₂O₅, MnO₂, TiO₂, CuO, CeO₂, Cr₂O₃, rare earth oxides in amounts of 0-5 weight-%, or 0-15 weight-%, for “black glass”, as well as fining agents such as As₂O₃, Sb₂O₃, SnO₂, SO₃, Cl, F, CeO₂ in amounts of 0-2 weight-%. The components of the glass composition always amount to 100 weight-%.

In one embodiment, the sheet is a glass ceramic which can consist of a ceramized alumino-silicate glass or a lithium-alumino silicate glass.

One exemplary glass-ceramic or ceramizable glass with the following composition of the starting glass can be used (in weight-%):

| | |
|---|---|
| Li₂O | 3.2-5.0 |
| Na₂O | 0-1.5 |
| K₂O | 0-1.5 |
| Sum Na₂O + K₂O | 0.2-2.0 |
| MgO | 0.1-2.2 |
| CaO | 0-1.5 |
| SrO | 0-1.5 |
| BaO | 0-2.5 |
| ZnO | 0-1.5 |
| Al₂O | 19-25 |
| SiO₂ | 55-69 |
| TiO₂ | 1.0-5.0 |
| ZrO₂ | 1.0-2.5 |
| SnO₂ | 0-1.0 |
| Sum TiO₂ + ZrO₂ + SnO₂ | 2.5-5.0 |
| P₂O₅ | 0-3.0. |

In another embodiment, a glass-ceramic or ceramizable glass with the following composition of the starting glass can be used (in weight-%):

| | |
|---|---|
| Li₂O | 3-5 |
| Na₂O | 0-1.5 |
| K₂O | 0-1.5 |
| Sum Na₂O + K₂O | 0.2-2 |
| MgO | 0.1-2.5 |
| CaO | 0-2 |
| SrO | 0-2 |
| BaO | 0-3 |
| ZnO | 0-1.5 |
| Al₂O₃ | 15-25 |
| SiO₂ | 50-75 |
| TiO₂ | 1-5 |
| ZrO₂ | 1-2.5 |
| SnO₂ | 0-1.0 |
| Sum TiO₂ + ZrO₂ + SnO₂ | 0.5-5 |
| P₂O₅ | 0-3.0. |

In another embodiment, a glass-ceramic or ceramizable glass with the following composition of the starting glass can be used (in weight-%):

| | |
|---|---|
| Li₂O | 3-4.5 |
| Na₂O | 0-1.5 |
| K₂O | 0-1.5 |
| Sum Na₂O + K₂O | 0.2-2 |
| MgO | 0-2 |
| CaO | 0-1.5 |
| SrO | 0-1.5 |
| BaO | 0-2.5 |
| ZnO | 0-2.5 |
| B₂O₃ | 0-1 |
| Al₂O₃ | 19-25 |
| SiO₂ | 55-69 |
| TiO₂ | 1.4-2.7 |
| ZrO₂ | 1.3-2.5 |
| SnO₂ | 0-0.4 |
| Sum TiO₂ + SnO₂ | less than 2.7 |
| P₂O₅ | 0-3 |
| Sum ZrO₂ + 0.87 (TiO₂ + SnO₂) | 3.6-4.3. |

The glass-ceramic can contain high quartz mixed crystals or keatite mixed crystals as predominant crystal phase. The crystal size can be less than 70 nm, such as less than or equal to 50 nm or less than or equal to 10 nm. The glass-ceramic can be produced according to known methods.

The glass surface can be subjected to a treatment prior to coating; it can, for example, be activated, as previously described. The glass can also be structured and/or etched.

After chemical strengthening, but prior to application of one or several additional layers, activation of the surface of the coating that is present on the surface of the thin glass sheet can occur.

It is assumed that, due to chemical strengthening, an accumulation of exchanged alkali metal ions—generally potassium ions—occurs in regions close to the surface in the thin glass sheet, as well as in the present layers. The long term stability of applied layers can thereby be considerably impaired. In order to prevent this, the surface of the uppermost layer of a coating present on the thin glass sheet can be activated after chemical tensioning and before the additional coating, so that the surface of the uppermost layer of the coating can better interact with an additional layer that is to be applied. Due to the activation, free binding sites on the surface of the uppermost layer are, for example, obtained or inorganic and/or organic contaminations that could counteract the desired interaction are removed. According to the present invention, the activation of the surface can also result in the surface becoming “rougher”. Due to the increased roughness, anchoring of the coating thereupon can be improved.

The activation of the surface of the layer (when only one layer is present), in particular of the surface of the outermost or uppermost layer (when several layers are present) can be implemented using one of the following variations:

(1) treatment of the surface with alkali-containing aqueous solution, which can have a pH>9, and subsequent washing with water, such as deionized or demineralized water;
(2) treatment of the surface with acidic aqueous solution, which can have a pH<6, and subsequent washing with water, such as deionized or demineralized water;
(3) treatment of the surface with alkali-containing aqueous solution, which can have a pH>9, then treatment of the surface with acidic aqueous solution, which can have a pH<6, and subsequent washing with water, such as deionized or demineralized water;
(4) washing of the surface with an aqueous washing solution, containing one or several tensides, then rinsing with water, such as deionized or demineralized water;
(5) washing of the surface with water, such as deionized or demineralized water;
(6) variation (1), variation (2), variation (3) or variation (4) in each case combined with an ultrasonic cleaning;
(7) treatment of the surface with oxygen plasma; and
(8) variation (1), variation (2), variation (3), variation (4), variation (5) or variation (6) in each case combined with treatment with oxygen plasma.

The selected variation depends on the glass composition as well as the composition and the structure of the coating. One skilled in the art is easily able to select the suitable variation and to optimize same with a few lesser indicative trials.

In addition to increasing the long term stability of layers that are applied onto previously activated layer surfaces, leaching out of alkali ions can also affect an increase in the chemical resistance of the layers.

Among other applications, an asymmetrically structured thin glass sheet that was produced according to the present invention can be used for monitors, in particular computer monitors, tablet computers or tablets, cell phones, smart phones, watches, smart watches, cameras, TVs, display screens such as large monitor displays, navigation devices, PDA- or handheld computers, notebooks or indicating instruments for motor vehicles or aircraft, covers for optical measuring devices or measuring sensors. The thin glass sheets can also be used for high-quality picture glazing.

The formed thin glass substrate can be used with coating for one of the following products:
protective screen for displays, indicator devices, touch screens;
cover screen for displays, indicator devices, touch screens;
as part of a touch panel;
as part of a touch screen with optical scanning; or
as part of inside a display system as a touch panel for interactive input of signals or as cover or protective screen.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic illustration of a top view onto the edges of two asymmetrically coated thin glasses, whereby the prior art thin glass displays strong warping after chemical strengthening;

FIG. 2A is a schematic illustration of a thin glass sheet formed according to the present invention, with a coating on the first surface side of the glass and a coating on the second surface side;

FIG. 2B is a schematic illustration of an asymmetrically coated thin glass sheet formed according to the present invention from a symmetrically coated intermediate product;

FIG. 3 is a schematic illustration of a thin glass sheet formed according to the present invention wherein on the first surface side of the thin glass a tin doping of the surface-near region (tin layer) is provided and on the second surface side of the thin glass, a coating is provided; and

FIG. 4 is a schematic illustration of a thin glass sheet formed according to the present invention, wherein on a first surface side of the thin glass a tin doping of the surface-near region is provided and, if required, an additional coating is present on the tin layer; and on the other surface side of the thin glass a coating.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

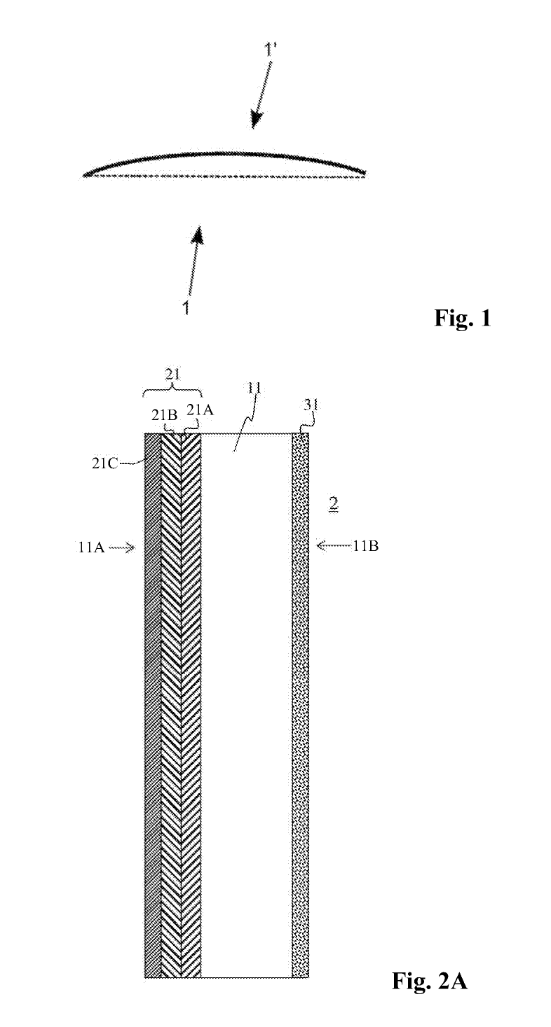

FIG. 1 is a schematic illustration of the top view onto an edge of 2 thin glasses, each of which only have one layer on one surface side, i.e., are asymmetrically structured. Thin glass sheet 1 (displayed as dashed lines) is a planar glass that was produced according to the present invention and that does not display any bending after chemical strengthening. In comparison hereto, an identical thin glass sheet 1′ is illustrated that, like thin glass sheet 1 also is coated. However, thin glass sheet 1′ was not manufactured according to the present invention, but was subjected to chemical strengthening in its original form according to the prior art. Thin glass sheet 1 does not warp after chemical strengthening. In comparison, thin glass sheet 1′ is illustrated showing a clear warp and, therefore, is no longer suitable for the intended application. After chemical strengthening, thin glass 1′ displays such a strong warp that, when being placed on a flat base, the center region of the thin glass is raised. This deviation of the surface of the thin glass 1′ from a level plane is so great that the glass can no longer be used as a cover glass for a smart phone or touch panel. The maximum deviation of the surface geometry of thin glass sheet 1′ can be 300 μm or more and can overall be even greater than the thickness of the thin glass sheet. Such a deformation can also be referred to as a convex deformation. The illustrated deformation is only one of several possible deformations which complicate use and further processing of the thin glass sheet. For example, the center region of the thin glass sheet may remain on the level and the corners or outside edges may lift.

In order to illustrate the differences in asymmetrically structured thin glasses in which one surface side is coated and one surface side is not coated, measured values were compiled in the following Table 1 to provide comparative examples that are available for asymmetrically structured glasses after chemical strengthening that were not manufactured according to the present invention. A coating consisting of one or several layers was applied always on one side of the glasses. The cited antireflective (AR-) coating was applied by the Sol-Gel method that consisted of a 3-layer design and included one layer each of medium, high and low refractive index. The cited tin layer was obtained in a float process. Table 1 below illustrates the difference in measured values for the coated and non-coated side of thin glass sheets that are not formed according to the present invention.

TABLE 1

| | | | | | | | | Depth of layer/DoL | | | | | |
|---|---|---|---|---|---|---|---|---|---|---|---|---|---|
| Comp. | | | | | | | | | | ΔDoL | ΔDoL | Warp (μm) | |
| Exam- | | Thick- | | | Strength- | Coating | | 1. | 2. | Between | Between | | Std. |
| ple | | ness | Manuf. | Manu- | en. | 1. | 2. | Side | Side | Both Sides | Both Sides | Averg. | Devi- |
| # | Glass | (mm) | process | facturer | Param. | side | side | (μm) | (μm) | (μm) | (%) | value | ation |
| 1 | Crown | 1 | Up- | Schott | 3.5 h | AR- | none | 19.0 | 23.3 | 4.3 | 22.6 | 624.2 | 134.8 |
| | Glass | | draw | | @465° C. | coating | | | | | | | |
| | (B270i) | | | | | | | | | | | | |
| 2 | Crown | 1 | Up- | Schott | 6 h | AR- | none | 18.5 | 22.5 | 4.0 | 21.6 | 592.0 | 86.0 |
| | Glass | | draw | | @450° C. | coating | | | | | | | |
| | (B270i) | | | | | | | | | | | | |
| 3 | Crown | 1 | Up- | Schott | 8 h | AR- | none | 14.1 | 18.2 | 4.1 | 29.1 | 504.0 | 23.5 |
| | Glass | | draw | | @450° C. | coating | | | | | | | |
| | (B270i) | | | | | | | | | | | | |
| 4 | Alumo- | 1 | Float | Schott | 3.5 h | tin layer* + | none | 42.1 | 50.3 | 8.2 | 19.5 | 1535.8 | 78.8 |
| | silicate | | process | | @465° C. | AR- | | | | | | | |
| | glass | | | | | coating | | | | | | | |
| 5 | Soda-lime | 1.1 | Float | Pilkington | 10 h | tin layer* + | none | 8.4 | 10.7 | 2.3 | 27.4 | 469.0 | 66.0 |
| | silicate | | process | | @420° C. | AR- | | | | | | | |
| | glass | | | | | coating | | | | | | | |
| 6 | Soda-lime | 1.1 | Float | Pilkington | 10 h | tin layer* + | none | 16.3 | 21.2 | 4.9 | 30.1 | 524.2 | 83.3 |
| | silicate | | process | | @465° C. | AR- | | | | | | | |
| | glass | | | | | coating | | | | | | | |
| 7 | Soda-lime | 1.1 | Float | Pilkington | 3.5 h | tin layer* + | none | 10.3 | 13.0 | 2.7 | 26.2 | 470.2 | 60.6 |
| | silicate | | process | | @465° C. | AR- | | | | | | | |
| | glass | | | | | coating | | | | | | | |
| 8 | Soda-lime | 1.1 | Float | Pilkington | 5 h | tin layer* + | none | 8.1 | 10.5 | 2.4 | 29.6 | 510.0 | 55.4 |
| | silicate | | process | | @440° C. | AR- | | | | | | | |
| | glass | | | | | coating | | | | | | | |
| 9 | Soda-lime | 1.1 | Float | Pilkington | 6 h | tin layer* + | none | 10.9 | 13.5 | 2.6 | 23.9 | 489.0 | 43.9 |
| | silicate | | process | | @450° C. | AR- | | | | | | | |
| | glass | | | | | coating | | | | | | | |
| 10 | Soda-lime | 1.1 | Float | Pilkington | 8 h | tin layer* + | none | 12.1 | 15.4 | 3.3 | 27.3 | 481.0 | 33.2 |
| | silicate | | process | | @450° C. | AR- | | | | | | | |
| | glass | | | | | coating | | | | | | | |
| 11 | Alumino- | | Float- | | 3.5 h | Tin layer* | AR- | 49.8 | 42.2 | 7.6 | 18.0 | 849.7 | 110.6 |
| | silicate | | process | | @465° C. | | coating | | | | | | |
| | glass | | | | | | | | | | | | |

*tin layer in float process

Comparison examples #1 to 3 illustrate that the one-sided anti-reflective Sol-Gel coating (AR-coating) leads to significant warping. Comparison examples 4 to 10 have an antireflective Sol-Gel coating on the first surface side on a tin side (tin layer). The asymmetrically structured glass displays significant warping. Comparison example #11 illustrates that with an alumino-silicate glass, the tin layer originating from the float process and the AR-Sol-Gel layer are not coordinated with each other. ΔDoL therefore is >7 μm. The glasses display significant warping and are therefore not suitable for practical application.

Examples #12 to 22 in the following Table 2 illustrate the values obtained in examples for the coated and non-coated side of thin glass sheets formed according to the present invention.

TABLE 2

| | | | | | | | | Depth of layer/DoL | | | | | |
|---|---|---|---|---|---|---|---|---|---|---|---|---|---|
| Comp. | | | | | | | | | | ΔDoL | ΔDoL | Warp (μm) | |
| Exam- | | Thick- | | | Strength- | Coating | | 1. | 2. | Between | Between | | Std. |
| ple | | ness | Manuf. | Manu- | en. | 1. | 2. | Side | Side | Both Sides | Both Sides | Averg. | Devi- |
| # | Glass | (mm) | process | facturer | Param. | side | side | (μm) | (μm) | (μm) | (%) | value | ation |
| 12 | Crown | 1.0 | Up- | Schott | 3.5 h | AR-coating | Reflective | 19.2 | 18.9 | 0.3 | 1.6 | 153.0 | 34.8 |
| | Glass | | draw | | @465° C. | | coating** | | | | | | |
| 13 | Crown | 1.0 | Up- | Schott | 6 h | AR-coating | Reflective | 18.5 | 18.0 | 0.5 | 2.8 | 174.3 | 32.8 |
| | Glass | | draw | | @450° C. | | coating** | | | | | | |
| 14 | Crown | 1.0 | Up- | Schott | 8 h | AR-coating | Reflective | 13.9 | 13.8 | 0.1 | 0.7 | 156.0 | 29.8 |
| | Glass | | draw | | @450° C. | | coating** | | | | | | |
| 15 | Soda-lime | 1.1 | Float | Schott | 10 h | Tin layer* | AR- | 8.9 | 9.4 | 0.5 | 5.6 | 147.6 | 19.2 |
| | silicate glass | | process | | @420° C. | | coating | | | | | | |
| 16 | Soda-lime | 1.1 | Float | Schott | 10 h | tin layer* | AR- | 18.5 | 19.0 | 0.5 | 2.7 | 198.4 | 29.2 |
| | silicate glass | | process | | @465° C. | | coating | | | | | | |
| 17 | Soda-lime | 1.1 | Float | Schott | 3.5 h | tin layer* | AR- | 11.1 | 11.2 | 0.1 | 0.9 | 168.3 | 29.1 |
| | silicate glass | | process | | @465° C. | | coating | | | | | | |
| 18 | Soda-lime | 1.1 | Float | Schott | 5 h | tin layer* | AR- | 8.9 | 9.4 | 0.5 | 5.6 | 141.5 | 24.8 |
| | silicate glass | | process | | @440° C. | | coating | | | | | | |
| 19 | Soda-lime | 1.1 | Float | Schott | 6 h | tin layer* | AR- | 11.3 | 11.8 | 0.5 | 4.4 | 166.1 | 27.0 |
| | silicate glass | | process | | @450° C. | | coating | | | | | | |
| 20 | Soda-lime | 1.1 | Float | Schott | 8 h | tin layer* | AR- | 13.0 | 13.5 | 0.5 | 3.9 | 160.3 | 26.1 |
| | silicate glass | | process | | @450° C. | | coating | | | | | | |
| 21 | Alumino- | 1.0 | Float | Schott | 3.5 h | tin layer* + | AR- | 47.0 | 45.0 | 2.0 | 4.4 | 176.3 | 23.5 |
| | silicate glass | | process | | @465° C. | bonding | coating | | | | | | |
| | | | | | | agent Sol- | | | | | | | |
| | | | | | | Gel layer | | | | | | | |
| 22 | Alumino- | 1.0 | Float | Schott | 3.5 h | tin layer* + | AR- | 47.3 | 44.8 | 2.5 | 5.6 | 178.4 | 32.1 |
| | silicate glass | | process | | @465° C. | CVD-layer | coating | | | | | | |
| | | | | | | (flame | | | | | | | |
| | | | | | | pyrolys.) | | | | | | | |

*tin layer in float process
**Sol-Gel layers

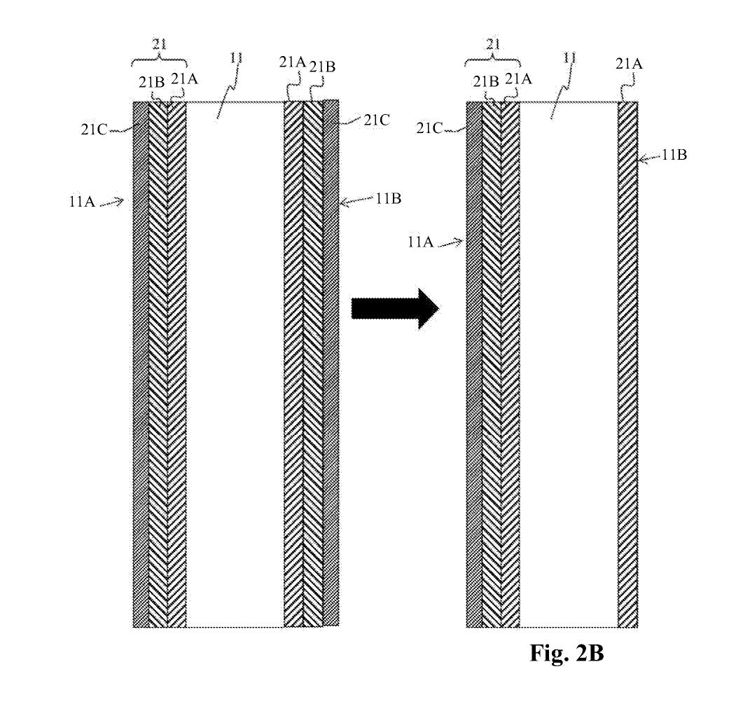

Below, exemplary design examples according to Table 2 are explained in detail with reference to FIGS. 2A to 4.

FIG. 2A is a schematic illustration of a thin glass sheet 2 that is formed according to one embodiment of the present invention comprising a glass sheet 11 with a first surface side of thin glass 11A and a second surface side of thin glass 11B. In the illustrated example, the glass sheet is a crown glass, drawn in a first step in the Up-Draw process, as offered by Schott AG/Mainz under the designation B270i®, having a thickness of 1.0 mm. Because of its high purity, the glass is suitable for high quality optical applications.

After forming the glass, the first surface side of thin glass 11A was coated with a coating 21 in a second step. This coating is an antireflective (AR-) coating for the visible spectral range, consisting of a three-layer system with: M layer 21A—a layer having a medium refractive index; T layer 21B—a layer having a high refractive index; and S layer 21C—a layer having a low refractive index.

In a third step, a layer 31 is applied onto the second surface side of glass 11B. Layer 31 can be any desired single- or multi-layer coating that remains stable under the conditions of chemical strengthening. An inorganic layer can be used. According to example #12, layer 31 represents a reflective coating in the form of a Sol-Gel coating. In regard to its properties, layer 31 is selected so that it is the same as, or adapted to the diffusion inhibition of coating 21. In particular, the DoL of layer 21 is set such that the difference of the depth of layers ΔDoL between layer 31 and coating 21 is 15% max., such as 10% max., 7% max., 6% max., or 5% max., whereby the %-values relate to the surface side with the lower depth of layers. In example #12, the difference of the depth of layers ΔDoL between layer 31 and coating 21 is 1.6%, whereby the %-values relate to layer 31.

Coated glass sheet 11 is subsequently chemically strengthened.

In example #12, 20 samples with thin glass sheet 2 dimension of 150×150 mm were chemically strengthened in a potassium nitrate melt for 3.5 hours at 465° C. (3.5 h @ 465° C.). The potassium ions of the melt diffused to a weakened, but uniform extent respectively through coating 21 consisting of 3 layers, and layer/layers 31 into the surface regions of sides 11A and 11B of thin glass sheet 2. Vice versa, the sodium ions of the glass diffuse out of the surface regions of sides 11A and 11B of glass sheet 1, also to a weakened, but uniform extent through coating 21 and layer 31 into the melt. Accordingly, regions where sodium ions are exchanged at least partially with potassium ions, form close to the surface on sides 11A and 11B.

The depth of layers was determined a photoelastic measurement.

The depth of layer of side 11A of thin glass sheet 2 that is coated with coating 21 was 19.2 μm. The depth of layer of side 11B of thin glass sheet 2 that is coated with layer 31 was 18.9 μm. The following therefore applies for ΔDoL: DoL₁=19.2 μm and DoL₂=18.9 μm, so that the difference between the two is 0.3 μm and thus ΔDoL=1.6%. The condition for crown glass according to the present invention was thereby met.

After chemical strengthening, bending or warping of the glass sheet was then measured. For this purpose, feeler gauges, i.e., metal strips of different and precisely defined thickness, or known flatness measuring devices can be used. Warping of thin glass sheet 2 with coating 21 and coating 31 was 153.0 μm (average value) after chemical strengthening. This deformation or bending is therefore within the range of tolerance, since the thin glass sheet can have a maximum deviation (warp) from flatness—measured along the diagonal along the entire length of the sheet surface, in particular along a length of 150 mm, of less than 300 μm, such as less than 250 μm or less than 200 μm.

The development of a bending or warping of the thin glass sheet during chemical strengthening can be prevented to a great extent, due to coating being applied on both sides and coordination in regard to the depth of layers. By providing layer 31, an adjustment occurred over the ion exchange on side 11B of the glass sheet relative to the ion exchange from side 11A that was coated with coating 21. Thus, balanced depths of layers result on both sides of thin glass substrate 2. Bending or warping of the chemically strengthened glass substrate 2 can herewith be prevented to a great extent.

Layer 31 can be removed again after chemical strengthening. In the current example #12, layer 31 is an antireflective coating layer that is present as a single layer which is not removed. The intermediate product is also the end product.

In FIG. 2B both sides of thin glass sheet 2 (mirror) are initially coated symmetrically with an AR-coating. After the manufacturing process, a thin glass sheet 2 was herein coated on both sides 11A and 11B—simultaneously or one after the other—respectively with an AR-coating 21. Thin glass sheet 2 was then chemically strengthened (left thin glass sheet in FIG. 2B). After chemical strengthening, the glass sheet can then, for example, be polished, thereby removing again part of the coating on second side 11B (right thin glass sheet in FIG. 2B). An asymmetrically coated thin glass sheet 2 results, that has an AR-coating on surface side 11A and only one layer on the other side. The warp on thin glass sheet 2 after chemical strengthening meets the desired conditions.

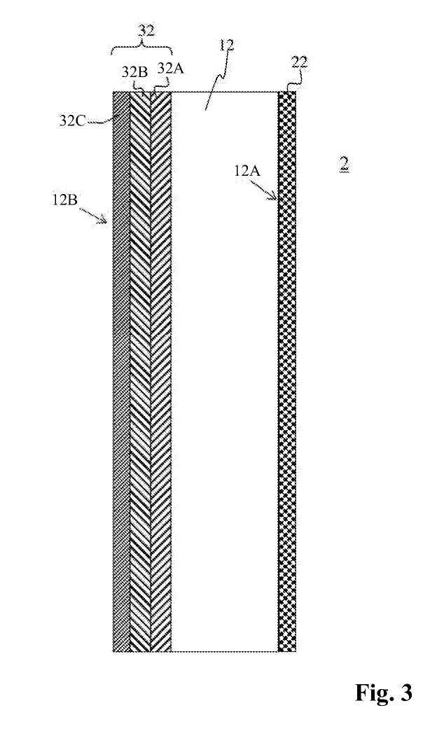

FIG. 3 is a schematic illustration of a thin glass sheet 12 that is formed according to another embodiment of the present invention and which comprises a first surface side of thin glass 12A and a second surface side of thin glass 12B. The glass sheet is a soda-lime silicate glass having a thickness of 1.1 mm. Illustrated thin glass sheet 12 is consistent with example #15. Glass sheet 12 was formed in a first step in the float process on a liquid tin bath. First surface side 12A was in contact with the tin bath (bath side), second surface side 12B was not in contact with the bath (air side). During the glass manufacturing process or the forming process, the surface region of first side 12A of glass sheet 12 was enriched or doped with tin. This tin-doped surface layer is also referred to as tin layer 22. Due to the presence of tin ions as network formers and/or network changers in the glass structure, only a diminished exchange of occurs during chemical strengthening of, for example, sodium or potassium ions.

After the completed glass manufacturing process, a coating 32 is applied to surface side 12B of glass sheet 12. This coating can be discretionary, it can be single- or multi-layer and may optionally represent one or several functional layers, providing coated glass substrate 2 with relevant characteristics, provided that same permits subsequent chemical strengthening.

In example #15, layer 32 is an AR-coating and is consistent with layer 21 in FIGS. 2A and 2B.

Subsequently, coated thin glass sheet 2 is chemically strengthened, as shown in FIG. 2A.

With strengthening conditions of 420° C. for 10 h, the depth of layer into the surface region on side 12A of thin glass sheet 12 with tin layer 22 was 8.9 μm. With strengthening conditions of 420° C. for 10 h, the depth of layer into the surface region on side 12B of thin glass sheet 12 with tin layer 32 was 9.4 μm. The following therefore applies for ΔDoL DoL₁=8.9 μm and DoL₂=9.4 μm, so that the difference between the two is 0.5 μm and thus ΔDoL=5.6%. The condition for soda-lime silicate glass according to the present invention was thereby met.

After chemical strengthening at 420° C. for 10 h, the deflection or warping of thin glass sheet 12 with coating 32 and tin layer 22 was 147.6 μm (average value) which is within the tolerance range for the thin glass sheet according to the present invention.

Due to the two-sided coating, formation of bending or warp of thin glass sheet 12 during chemical strengthening could be prevented to a large extent. By providing coating 32, a balancing of the ion-exchange on side 12B of the glass sheet occurred with the ion-exchange from side 12A that was provided with tin layer 22. This results in balanced depth of layers on both sides of thin glass sheet 12. Bending or warping of the chemically tensioned thin glass substrate 2 can thereby be reduced.

If the diffusion inhibition is not sufficient due to the diffusion properties of coating 32 or layer 22, then an additional layer can be applied onto coating 32 and/or layer 22, so that the sum of the diffusion properties of the coating is consistent on both sides.

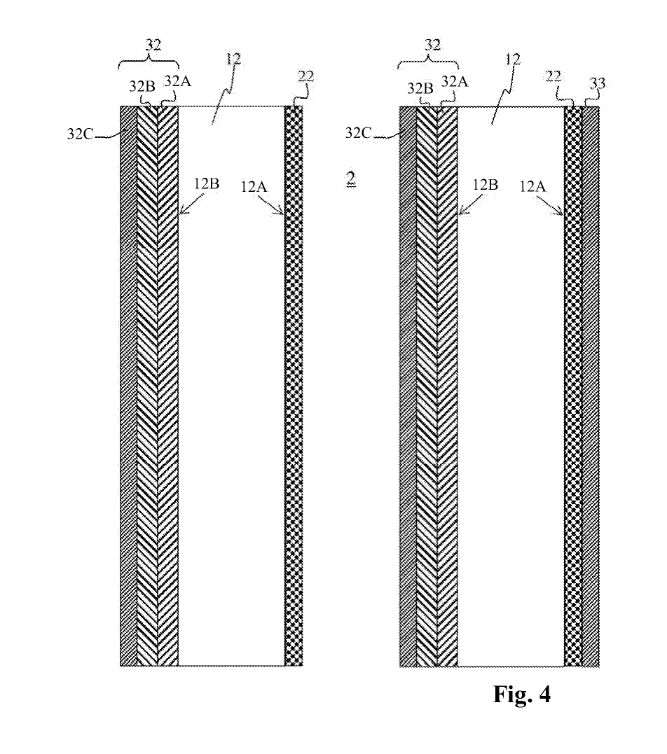

This type of approach is illustrated in FIG. 4. First, a thin glass sheet 2 as described in FIG. 3 was produced and chemically strengthened. It was, however, found that the value for ΔDoL for the resulting thin glass sheet could not be reduced to the desired extent. After chemical strengthening, the glass sheet displayed strong warping since the coatings were not coordinated with each other. ΔDoL was at 18 μm (Table 1: Example 11). Therefore, an additional coating 33 was applied onto tin layer 22 as an improvement prior to chemical strengthening, for example in the form of a bonding agent layer or CVF-layer. This approach is consistent with examples 21 or 22. Subsequently, a desired ΔDoL could be achieved, so that bending of the thin glass sheet could be sufficiently reduced.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### REFERENCE LIST

| | |
|---|---|
| 1′ | Asymmetric thin glass sheet, coated on one side |
| | (according to the prior art) |
| 1, 2 | Asymmetrically structured thin glass sheet |
| | (according to the invention) |
| 11, 12 | Glass sheet |
| 11a, 11b, 12a, 12b | Surface sides of the glass sheet |
| 21, 32 | Multi-layer coating |
| 22 | Surface doped with tin or tin layer |
| 21a, 21b, 21c, | Individual layers of the multi-layer coating |
| 32a, 32b, 32c | |
| 31 | Single- or multi-layer coating |
| 33 | Bonding agent- or CVD-layer |

What is claimed is:

1. A thin glass sheet, comprising:
a first surface side which is chemically strengthened, said first surface side having a first depth of layer of alkali ions (DoL₁) introduced through chemical strengthening;
at least one layer of a first coating provided on said first surface side;
a second surface side differing from said first surface side in at least one property or characteristic and which is chemically strengthened, said second surface side having a second depth of layer of alkali ions (DoL₂) introduced through chemical strengthening, said DoL₂ and said DoL₁ being coordinated with each other in such a way that DoL₂ and DoL₁ are equal or are adapted on both surface sides; and
at least one layer of a second coating provided on said second surface side, said second coating differing from said first coating in at least one property or characteristic.

2. The thin glass sheet according to claim 1, wherein said at least one differing property or characteristic between said first coating and said second coating is at least one of a thickness, a porosity, a number of coating layers, a structure, a composition of layer(s), and a manufacturing process of the layer(s).

3. The thin glass sheet according to claim 1, further comprising at least one layer of tin atoms diffused into said second surface.

4. The thin glass sheet according to claim 1, wherein said thin glass sheet comprises at least one of a silicate glass, a soda-lime-silica glass, a crown glass, and a borosilicate glass and said DoL₁ and said DoL₂ are adapted such that a difference between said DoL₁ and said DoL₂ (ΔDoL) is less than or equal to 15% of the lesser depth of layer.

5. The thin glass sheet according to claim 4, wherein said ΔDoL is less than or equal to 5% of the lesser depth of layer.

6. The thin glass sheet according to claim 1, wherein said thin glass sheet comprises an alumino-silicate glass and said DoL₁ and said DoL₂ are adapted such that a difference between said DoL₁ and said DoL₂ (ΔDoL) is less than or equal to 10% of the lesser depth of layer.

7. The thin glass sheet according to claim 6, wherein said ΔDoL is less than or equal to 3.5% of the lesser depth of layer.

8. The thin glass sheet according to claim 1, wherein said DoL₁ and said DoL₂ are adapted to one another such that said thin glass sheet has a maximum deviation from flatness of less than 300 μm.

9. The thin glass sheet according to claim 1, wherein said thin glass sheet has a thickness of less than 3 mm.

10. The thin glass sheet according to claim 1, wherein said thin glass sheet is a silicate glass having a composition comprising, in weight-%:

| | |
|---|---|
| SiO₂ | 10-90; |
| AI₂O₃ | 0-40; |
| B₂O₃ | 0-80; |
| Na₂O | 1-30; |
| K₂O | 0-30; |
| CoO | 0-20; |
| NiO | 0-20; |
| Ni₂O₃ | 0-20; |
| MnO | 0-20; |
| CaO | 0-40; |
| BaO | 0-60; |
| ZnO | 0-40; |
| ZrO₂ | 0-10; |
| MnO₂ | 0-10; |
| CeO | 0-3; |
| SnO₂ | 0-2; |
| Sb₂O₃ | 0-2; |
| TiO₂ | 0-40; |
| P₂O₅ | 0-70; |
| MgO | 0-40; |
| SrO | 0-60; |
| Li₂O | 0-30; |
| Li₂O + Na₂O + K₂O | 1-30; |
| SiO₂ + B₂O₃ + P₂O₅ | 10-90; |
| Nd₂O₅ | 0-20; |
| V₂O₅ | 0-50; |
| Bi₂O₃ | 0-50; |
| SO₃ | 0-50; and |
| SnO | 0-70, |

wherein a content of SiO₂+P₂O₅+B₂O₃ is 10-90 weight-%.

11. The thin glass sheet according to claim 10, wherein said silicate glass is a soda-lime-silica glass having a composition comprising, in weight-%:

| | |
|---|---|
| SiO₂ | 40-80; |
| Al₂O₃ | 0-6; |
| B₂O₃ | 0-5; |
| Sum Li₂O + Na₂O + K₂O | 5-30; |
| Sum MgO + CaO + SrO + BaO + ZnO | 3-30; |
| Sum TiO₂ + ZrO₂ | 0-7; and |
| P₂O₅ | 0-2. |

12. The thin glass sheet according to claim 10, wherein said silicate glass is a crown glass having a composition comprising, in weight-%:

| | |
|---|---|
| SiO₂ | 52-80; |
| Al₂O₃ | 0-15; |
| B₂O₃ | 0-14; |
| Na₂O | 2-16; |
| K₂O | 5-25; |
| MgO | 0-6; |
| CaO | 0-14; |
| ZrO₂ | 0-8; |
| ZnO | 0-6; |
| TiO₂ | 0-5; |
| Sum SrO + BaO | 0-15; and |
| PbO | 0-25. |

13. The thin glass sheet according to claim 10, wherein said silicate glass is a borosilicate glass having a composition comprising, in weight-%:

| | |
|---|---|
| SiO₂ | 60-85; |
| Al₂O₃ | 1-10; |
| B₂O₃ | 5-20; |
| Sum Li₂O + Na₂O + K₂O | 2-16; |
| Sum MgO + CaO + SrO + BaO + ZnO | 0-15; |
| Sum TiO₂ + ZrO₂ | 0-5; and |
| P₂O₅ | 0-2. |

14. The thin glass sheet according to claim 10, wherein said silicate glass is an alkali-alumino silicate glass having a composition comprising, in weight-%:

| | |
|---|---|
| SiO₂ | 40-75; |
| Al₂O₃ | 10-30; |
| B₂O₃ | 0-20; |
| Sum Li₂O + Na₂O + K₂O | 4-30; |
| Sum MgO + CaO + SrO + BaO + ZnO | 0-15; |
| Sum TiO₂ + ZrO₂ | 0-15; and |
| P₂O₅ | 0-10. |

15. The thin glass sheet according to claim 10, wherein said silicate glass is a lithium-alumino silicate glass having a composition comprising, in weight-%:

| | |
|---|---|
| SiO₂ | 55-69; |
| AI₂O₃ | 18-25; |
| Li₂O | 3-5; |
| Sum Na₂O + K₂O | 0-30; |
| Sum MgO + CaO + SrO + BaO | 0-5; |
| ZnO | 0-4; |
| TiO₂ | 0-5; |
| ZrO₂ | 0-3; |
| Sum TiO₂ + ZrO₂ + SnO₂ | 2-6; |
| P₂O₅ | 0-8; |
| F | 0-1; and |
| B₂O₃ | 0-2. |

16. The thin glass sheet according to claim 10, wherein said silicate glass is a low alkali content alumino silicate glass having a composition comprising, in weight-%:

| | |
|---|---|
| SiO₂ | 50-75; |
| AI₂O₃ | 7-25; |
| B₂O₃ | 0-20; |
| Sum Li₂O + Na₂O + K₂O | 1-4; |
| Sum MgO + CaO + SrO + BaO + ZnO | 5-25; |
| Sum TiO₂ + ZrO₂ | 0-10; and |
| P₂O₅ | 0-5. |

17. The thin glass sheet according to claim 10, wherein said composition further comprises at least one of a coloring oxide, 0-15 weight-% of at least one rare earth oxide, and 0-2 weight-% of a fining agent.

18. The thin glass sheet according to claim 1, wherein said thin glass sheet is a glass-ceramic or ceramizable glass with a starting glass having a composition comprising, in weight-%:

| | |
|---|---|
| Li₂O | 3.2-5.0; |
| Na₂O | 0-1.5; |
| K₂O | 0-1.5; |
| Sum Na₂O + K₂O | 0.2-2.0; |
| MgO | 0.1-2.2; |
| CaO | 0-1.5; |
| SrO | 0-1.5; |
| BaO | 0-2.5; |
| ZnO | 0-1.5; |
| Al₂O | 19-25; |
| SiO₂ | 55-69; |
| TiO₂ | 1.0-5.0; |
| ZrO₂ | 1.0-2.5; |
| SnO₂ | 0-1.0; |
| Sum TiO₂ + ZrO₂ + SnO₂ | 2.5-5.0; and |
| P₂O₅ | 0-3.0. |

19. The thin glass sheet according to claim 1, wherein said thin glass sheet is a glass-ceramic or ceramizable glass with a starting glass having a composition comprising, in weight-%:

| | |
|---|---|
| Li₂O | 3-5; |
| Na₂O | 0-1.5; |
| K₂O | 0-1.5; |
| Sum Na₂O + K₂O | 0.2-2; |
| MgO | 0.1-2.5; |
| CaO | 0-2; |
| SrO | 0-2; |
| BaO | 0-3; |
| ZnO | 0-1.5; |
| Al₂O₃ | 15-25; |
| SiO₂ | 50-75; |
| TiO₂ | 1-5; |
| ZrO₂ | 1-2.5; |
| SnO₂ | 0-1.0; |
| Sum TiO₂ + ZrO₂ + SnO₂ | 0.5-5; and |
| P₂O₅ | 0-3.0. |

20. The thin glass sheet according to claim 1, wherein said thin glass sheet is a glass-ceramic or ceramizable glass with a starting glass having a composition comprising, in weight-%:

| | |
|---|---|
| Li₂O | 3-4.5; |
| Na₂O | 0-1.5; |
| K₂O | 0-1.5; |
| Sum Na₂O + K₂O | 0.2-2; |
| MgO | 0-2; |
| CaO | 0-1.5; |
| SrO | 0-1.5; |
| BaO | 0-2.5; |
| ZnO | 0-2.5; |
| B₂O₃ | 0-1; |
| Al₂O₃ | 19-25; |
| SiO₂ | 55-69; |
| TiO₂ | 1.4-2.7; |
| ZrO₂ | 1.3-2.5; |
| SnO₂ | 0-0.4; |
| Sum TiO₂ + SnO₂ | less than 2.7; |
| P₂O₅ | 0-3; and |
| Sum ZrO₂ + 0.87 (TiO₂ + SnO₂) | 3.6-4.3. |

21. The thin glass sheet according to claim 1, wherein said thin glass sheet is included in at least one of a monitor, a computer monitor, a tablet computer, a television, a display screen, a navigation device, a cell phone, a watch, a measuring sensor, a camera, a handheld computer, an indicating instrument, a motor vehicle, an aircraft, a picture glazing, a protective screen, a cover screen, a touch panel, a touch screen, and a display system.
